(19) United States
(12) Patent Application Publication
(10) Pub. No.: US 2025/0249924 A1
(43) Pub. Date: Aug. 7, 2025

(54) NOTIFICATION CONTROL DEVICE, NOTIFICATION CONTROL METHOD AND MEDIUM STORING NOTIFICATION CONTROL PROGRAM

(71) Applicant: DENSO CORPORATION, Kariya-city (JP)

(72) Inventors: Takuya KUME, Kariya-city (JP); Kazuki Izumi, Kariya-city (JP)

(21) Appl. No.: 19/186,216

(22) Filed: Apr. 22, 2025

Related U.S. Application Data
(63) Continuation of application No. PCT/JP2023/041273, filed on Nov. 16, 2023.

(30) Foreign Application Priority Data
Dec. 9, 2022 (JP) 2022-197268

(51) Int. Cl. B60W 50/14; B60K 35/28; B60W 30/18; B60W 30/182; B60W 60/00

(52) U.S. Cl. CPC B60W 50/14; B60K 35/28; B60W 30/18009; B60W 30/182; B60W 60/001; B60K 2360/166; B60K 2360/1868; B60K 2360/195; B60W 2050/146

(57) ABSTRACT

A technique for controlling notification is used in a vehicle configured to execute automated driving control. In the technique, data indicating whether the vehicle is operating under the automated driving control is acquired. Information about a gate point, which is a point where multiple gates are provided on a toll road, is acquired. It is determined whether the vehicle has entered a gate area defined with reference to the gate point. A notification is executed to prompt a driver to check a surrounding traffic condition based on the vehicle entering the gate area under the automated driving control.

### CROSS REFERENCE TO RELATED APPLICATIONS

The present application is a continuation application of International Patent Application No. PCT/JP2023/041273 filed on Nov. 16, 2023, which designated the U.S. and claims the benefit of priority from Japanese Patent Application No. 2022-197268 filed on Dec. 9, 2022. The disclosures of all the above applications are incorporated herein.

### TECHNICAL FIELD

The present disclosure relates to a technology for controlling notification to a driver when passing through a toll gate on a toll road in automated driving.

### BACKGROUND

A vehicle control device is used for a vehicle that passes through toll road gates using automated driving. The vehicle control device is capable of changing the gate to be passed through depending on whether or not a card for toll payment is installed in the vehicle.

### SUMMARY

A technique for controlling notification is used in a vehicle configured to execute automated driving control. In the technique, data indicating whether the vehicle is operating under the automated driving control is acquired. Information about a gate point, which is a point where multiple gates are provided on a toll road, is acquired. It is determined whether the vehicle has entered a gate area defined with reference to the gate point. A notification is executed to prompt a driver to check a surrounding traffic condition based on the vehicle entering the gate area under the automated driving control.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating a configuration of an automated driving system.

FIG. 2 is a functional block diagram illustrating an automated driving ECU.

FIG. 3 is a diagram for explaining a process of setting a target gate.

FIG. 4 is a flowchart illustrating an operation of the automated driving ECU when passing through a gate.

FIG. 5 is a diagram illustrating an example of an icon image displayed as an eyes-on request.

FIG. 6 is a diagram illustrating an example of a gate guidance image.

FIG. 7 is a diagram illustrating another example of a gate guidance image.

FIG. 8 is a flowchart illustrating an example of an operation of a notification control unit based on presence or absence of a surrounding vehicle.

FIG. 9 is a flowchart illustrating another example of the operation of the notification control unit based on presence or absence of a surrounding vehicle.

FIG. 10 is a flowchart illustrating an example of the operation of the notification control unit according to a settlement method of the target gate.

FIG. 11 is a flowchart for explaining an example of the operation of the notification control unit according to an operation mode of the automated driving ECU when entering a gate area.

FIG. 12 is a flowchart for explaining an example of the operation of the notification control unit according to whether to implement a route change in the gate area.

FIG. 13 is a flowchart for explaining a case where a display content of the gate guidance image is changed according to the operation mode of the automated driving ECU when entering the gate area.

FIG. 14 is a diagram illustrating an example of a gate passage icon.

FIG. 15 is a diagram for explaining a case where the display content of the gate guidance image is changed depending on whether the vehicle is following a preceding vehicle when entering the gate area.

FIG. 16 is a diagram illustrating an example of a gate image without a track.

FIG. 17 is a diagram illustrating an example of control in an operation mode.

FIG. 18 is a diagram illustrating another example of control in an operation mode.

FIG. 19 is a diagram illustrating another example of control in an operation mode.

### DETAILED DESCRIPTION

According to a comparative example, a vehicle control device passes through toll road gates using automated driving. The vehicle control device is capable of changing the gate to be passed through depending on whether or not a card for toll payment is installed in the vehicle.

Near the gate, traveling paths of vehicles are more likely to intersect, increasing the risk of collisions compared to traveling on a straight road.

In contrast, according to the present disclosure, a notification control device and a notification control method are capable of reducing a possibility of contact with another vehicle when traveling near a gate during automated driving.

A notification control device disclosed herein is a notification control device for use in a vehicle configured to execute automated driving control. The notification control device includes a control device configured to acquire data indicating whether the vehicle is operating under the automated driving control. The control device configured to acquire information about a gate point which is a point where multiple gates are provided on a toll road. The control device configured to determine whether the vehicle has entered a gate area defined with reference to the gate point. The control device configured to execute a notification to prompt a driver to check a surrounding traffic condition based on the vehicle entering the gate area under the automated driving control.

A notification control method disclosed herein is a notification control method executed by a processor included in a vehicle configured to execute automated driving control. In the method, data indicating whether the vehicle is operating under the automated driving control is acquired. Information about a gate point, which is a point where multiple gates are provided on a toll road, is acquired. It is determined whether the vehicle has entered a gate area defined with reference to the gate point. A notification is executed to prompt a driver to check a surrounding traffic condition based on the vehicle entering the gate area under the automated driving control.

According to the above device/method, in the vicinity of the gate, not only the automated driving system but also the driver can check the surrounding traffic conditions. Therefore, even if there is another vehicle excessively approaching the subject vehicle, the likelihood that the vehicle will be properly operated by the driver can be increased. As a result, the risk of contact with other vehicles can be reduced.

### Introduction

Hereinafter, one embodiment of the present disclosure will be described with reference to the drawings. The present disclosure is not limited to the following embodiments, and various modifications can be made without departing from the scope of the gist described below. The various supplements and modifications described below can be implemented in appropriate combinations as long as no technical contradictions arise. For components having the same function, the same reference numerals are used, and their descriptions may be omitted. Additionally, when referring to only a part of the configuration, the explanation provided earlier can be applied to the other parts.

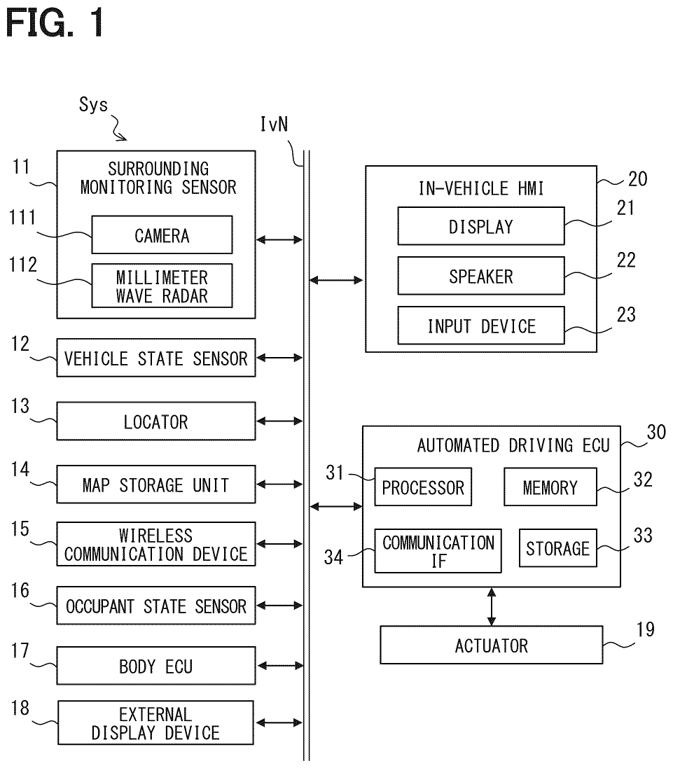

FIG. 1 is a diagram showing an example of a schematic configuration of an automated driving system Sys according to the present disclosure. Hereafter, a vehicle on which the automated driving system Sys is mounted is also described as a subject vehicle. In the present disclosure, the description “subject-vehicle lane” refers to a lane in which the subject vehicle is traveling among the multiple lanes provided on the road. The subject-vehicle lane can also be referred to as an ego lane. An adjacent lane refers to a lane that is next to the subject-vehicle lane.

In the present disclosure, a preceding vehicle refers to a vehicle that is traveling in the same lane as the subject vehicle and is the closest vehicle to the subject vehicle among vehicles present in front of the subject vehicle. A following vehicle refers to another vehicle that is traveling behind the subject vehicle in the same lane as the subject vehicle. A forward vehicle includes not only the vehicle traveling ahead of the subject vehicle in the same lane but also other vehicles traveling ahead of the subject vehicle in one or more adjacent lanes. Similarly, a rear vehicle includes not only the following vehicle but also vehicles traveling diagonally behind the subject vehicle.

In the present disclosure, the term “driver” refers to a person seated in a driver's seat, i.e., a driver seat occupant, regardless of whether he or she is actually driving. For example, in the present disclosure, the term “driver” may refer to a person who should receive the authority and responsibility for vehicle operation from the automated driving system Sys upon the termination of automated driving. The term “driver” in the present disclosure can be replaced with “driver seat occupant.” The subject vehicle may be a remotely operated vehicle controlled by an operator located outside the vehicle. The person who takes over the driving operation from the automated driving system Sys may be an operator located outside the vehicle. Here, the term “operator” refers to a person who has the authority to control the vehicle remotely from outside the vehicle. The operator is also included in the concept of the driver.

The automated driving system Sys provides a so-called automated driving function that allows the subject vehicle to travel autonomously along a predetermined route. The degree of automation of driving operations (hereinafter referred to as the automation level) can have multiple levels, as defined by the Society of Automotive Engineers (SAE International). The automation levels can be classified into six stages, for example, from Level 0 to Level 5.

Level 0 corresponds to fully manual driving, where the system does not perform any control. Level 1 is a level where the system supports either steering or acceleration/deceleration. Level 1 includes cases where only Adaptive Cruise Control (ACC) is executed. Level 2 refers to the level where the system performs both speed adjustment through accelerator and brake operations, and lateral control through steering wheel operations (i.e., steering). In Level 2, although driver monitoring of the surroundings (so-called “eyes-on”) is required, the system substantially allows the vehicle to drive autonomously. In this disclosure, Level 2 equivalent control is also referred to as automated driving control with surrounding monitoring obligations, Level 2 automated driving control, or semi-automated driving control.

Level 3 refers to the level where the system performs all driving tasks within the Operational Design Domain (ODD), while in emergencies, the control authority is transferred from the system to the driver. The ODD defines the conditions under which automated driving can be executed. Level 4 is the level at which the system performs all driving tasks, except in specific situations such as predetermined roads or extreme environments where it is not capable of operating. Level 5 is the level at which the system performs all driving tasks in all environments.

Automation levels 3 to 5 are the levels at which driver monitoring of the surroundings is not required, in other words, these levels correspond to automated driving. Therefore, in this disclosure, vehicle control corresponding to level 3 or higher is also referred to as automated driving control without the obligation of surrounding monitoring.

The following automated driving system Sys can be appropriately modified and implemented to conform to the regulations and customs of the region where it is used, as well as the characteristics and equipment of the installed vehicle. Unless otherwise specified, the term “system” hereinafter refers to the automated driving system Sys.

### Overall Configuration of the Automated Driving System Sys

The automated driving system Sys includes various configurations as shown in FIG. 1, as an example. That is, the automated driving system Sys includes a surrounding monitoring sensor 11, a vehicle state sensor 12, a locator 13, a map storage unit 14, a wireless communication device 15, an occupant state sensor 16, a body ECU 17, an external display device 18, and a driving actuator 19. In addition, the automated driving system Sys includes an in-vehicle HMI 20 and an automated driving ECU 30 (controller). It should be noted that ECU stands for Electronic Control Unit, which means an electronic control device. HMI stands for Human Machine Interface.

The automated driving ECU 30 is connected to each of the above-mentioned devices/sensors, such as the surrounding monitoring sensor 11, via an in-vehicle network IvN, enabling mutual communication. The in-vehicle network IvN is a communication network constructed within the vehicle. The standards for the in-vehicle network IvN can include various specifications such as Controller Area Network (hereinafter referred to as CAN: registered trademark) and Ethernet (registered trademark). Additionally, some of the devices/sensors may be directly connected to the automated driving ECU 30 via dedicated signal lines. The connection configurations between the devices can be modified as needed.

The surrounding monitoring sensor 11 is a sensor that detects objects present within its detection range. The surrounding monitoring sensor 11 can be understood as an autonomous sensor that senses the surrounding environment of the subject vehicle. The surrounding monitoring sensor can be referred to as an object detection sensor. The automated driving system Sys may be equipped with multiple surrounding monitoring sensors 11. The automated driving system Sys includes, for example, a camera 111 and a millimeter wave radar 112 as the surrounding monitoring sensors 11.

The camera 111 is a so-called front camera, which is arranged to capture images of the area in front of the vehicle at a predetermined angle of view. The camera 111 is positioned at a location such as the upper end of the interior side of the windshield, the front grille, or the rooftop. The camera 111 may include a camera ECU in addition to a camera body that generates image frames. The camera body includes at least an image sensor and a lens. The camera ECU includes a processor and memory. The processor is a CPU (Central Processing Unit) or a GPU (Graphics Processing Unit), for example. The camera ECU is an ECU that detects a predetermined target object by performing recognition processing on the image frames. The camera ECU detects and identifies objects registered as detection targets by using, for example, a classifier to which deep learning has been applied. In addition, the camera ECU calculates the relative position coordinates of the detected object with respect to the subject vehicle based on the position information (for example, pixel coordinates) of the detected object within the image frame.

The detection targets of the camera 111 include, for example, pedestrians and other moving objects such as other vehicles. The detection targets of the camera 111 also include static objects such as road edges, road markings, and structures installed along the roadside. Road markings include lane lines indicating lane divisions, pedestrian crossings, stop lines, guide lanes, safety zones, and regulatory arrows. Structures installed along the roadside include road signs, guardrails, curbs, utility poles, and traffic signals. The camera 111 can also detect the lighting status of illumination devices such as hazard lamps and turn signals (commonly known as blinkers) of the forward vehicle.

The automated driving system Sys may be equipped with multiple cameras 111. For example, the automated driving system Sys may be equipped with a side camera for capturing images of the sides of the vehicle and a rear camera for capturing images of the rear of the vehicle, in addition to the front camera, as the multiple cameras 111. The function of detecting target objects by analyzing camera images may be provided by other ECUs, such as the automated driving ECU 30. The functional arrangement within the automated driving system Sys can be modified as needed. The camera 111 outputs data related to detected objects to the in-vehicle network IvN. The data transmitted through the in-vehicle network IvN is referenced as needed by the automated driving ECU 30.

The millimeter wave radar 112 is a device that transmits probe waves, such as millimeter waves or quasi-millimeter waves, in a predetermined direction and analyzes the received data of the reflected waves that return after being reflected by objects, thereby detecting the relative position and relative speed of objects with respect to the subject vehicle. The automated driving system Sys may be equipped with multiple millimeter wave radars 112. The multiple millimeter wave radars 112 include a front millimeter wave radar and a rear millimeter wave radar. The front millimeter wave radar is a millimeter wave radar 112 that transmits probe waves towards the front of the vehicle and is installed, for example, in the front grille or the front bumper. The rear millimeter wave radar is a millimeter wave radar 112 that transmits probe waves towards the rear of the vehicle and is installed, for example, in the rear bumper. Each millimeter wave radar 112 generates data indicating the relative position and relative speed of detected objects and outputs this detection result to the automated driving ECU 30 or other relevant systems. The detection targets of the millimeter wave radar 112 may include other vehicles, pedestrians, manholes (iron plates), and three-dimensional structures used as landmarks, for example.

The surrounding monitoring sensors 11 may include not only the camera 111 and the millimeter wave radar 112 but also LiDAR, sonar, and other such sensors. LIDAR stands for Light Detection and Ranging, or Laser Imaging Detection and Ranging. LiDAR is a device that emits laser light to generate three-dimensional point cloud data indicating the positions of reflection points in each detection direction. LIDAR is also referred to as laser radar. The automated driving system Sys may also be equipped with multiple LiDARs and sonars. The combination of the surrounding monitoring sensors 11 provided in the automated driving system Sys can be changed as appropriate. The detection results from each surrounding monitoring sensor 11 are input into the automated driving ECU 30.

The vehicle state sensor 12 is a sensor that detects information related to the state of the subject vehicle. The vehicle state sensor 12 includes a speed sensor, a steering angle sensor, an acceleration sensor, a yaw rate sensor, and an accelerator pedal sensor. The speed sensor is a sensor that detects the driving speed of the subject vehicle. The steering angle sensor is a sensor that detects the steering angle. The acceleration sensor is a sensor that detects the acceleration acting in the longitudinal direction and the lateral acceleration acting in the lateral direction of the subject vehicle. The yaw rate sensor is a sensor that detects the angular velocity of the subject vehicle. The accelerator pedal sensor is a sensor that detects the depression amount/force of the accelerator pedal. The brake pedal sensor is a sensor that detects the depression amount/force of the brake pedal. The vehicle state sensor 12 outputs data indicating the current value (i.e., the detection result) of the physical state quantity to be detected to the in-vehicle network IvN. The types of sensors used by the automated driving system Sys as the vehicle state sensor 12 can be appropriately designed as needed.

The locator 13 is a device that calculates and outputs the position coordinates of the subject vehicle using navigation signals transmitted from positioning satellites that constitute the GNSS (Global Navigation Satellite System). The locator 13 includes a GNSS receiver and inertial sensors, for example. The locator 13 combines the navigation signals received by the GNSS receiver, measurement results from the inertial sensors, and vehicle speed information transmitted through the in-vehicle network IvN to sequentially calculate the subject vehicle's position and direction of travel. In this disclosure, the data indicating the position coordinates of the subject vehicle calculated by the locator 13 is referred to as subject-vehicle position data. The locator 13 outputs the subject-vehicle position data to the automated driving ECU 30.

The map storage unit 14 is a storage device that stores map data. The map data held by the map storage unit 14 may be so-called HD (High Definition) map data. The map data stored in the map storage unit 14 includes the three-dimensional shape of roads, the positions of road markings such as lane lines, and the positions of traffic signs, all with the accuracy required for automated driving and other applications. The map data includes gate point data for each gate point. A gate point is a location on a toll road where a gate is installed for toll collection. The terms gate point/gate in this disclosure can be interpreted as toll booth.

Gate point data is data that indicates the structure and other characteristics of the gate point. At a single gate point, multiple gates can be installed side by side in the road width direction. The gate point data includes a representative location coordinate, the number of installed gates, the detailed position of each gate, and data related to the settlement method for each gate. The number of installed gates can be referred to as the number of lanes. Each gate provides a single lane (passage). The representative location coordinate is a coordinate that roughly indicate the position of the gate point. The representative location coordinate may be, for example, a coordinate of a gate (hereinafter referred to as a representative gate) located in the middle, at the right end, or at the left end among multiple gates arranged side by side.

In this disclosure, a road section within a predetermined distance before and after the gate point represented by the representative location coordinate is referred to as a gate area. The gate area may be a section before and after the gate where no lane lines are provided (hereinafter, referred to as a lane-free section). The gate area may be a section where the road width is expanded relative to the road connected to the gate area. The gate area can be divided into a pre-gate area and a post-gate area. The pre-gate area refers to a region within the gate area that is located on the entrance side of the gate (in other words, a near side). The post-gate area refers to a region within the gate area that is located on the exit side of the gate (in other words, a far side). If there is a branching point after the gate, the processor 31 may recognize an area up to the branching point as the post-gate area.

The detailed position data of each gate may be coordinate data such as latitude and longitude. The detailed position of each gate may be expressed by a number determined with the rightmost or leftmost gate being designated as number one. The data on the settlement method indicates the method of settling (paying) road tolls. The settlement method can be classified into manual settlement and automatic settlement methods. The manual settlement method involves the driver paying the toll by handing cash or a credit card to the gate staff, or by inserting it into a payment machine installed at the gate. The automatic settlement method involves a wireless communication device installed in the vehicle (commonly known as an on-board unit) communicating with wireless communication equipment installed at the gate (commonly known as a roadside unit) to process the payment according to the vehicle type and the section of the road traveled. In Japan, the manual settlement method may be referred to as “General,” while the automatic settlement method may be referred to as “ETC (registered trademark).” ETC stands for Electronic Toll Collection.

The map data stored in the map storage unit 14 may be updated with data received by the wireless communication device 15 from a map server or similar source. The map storage unit 14 may be a storage device that temporarily holds map data received by the wireless communication device 15 from a map server until the validity date of the data expires. The map data held by the map storage unit 14 may be navigation map data as long as it includes gate point data.

The wireless communication device 15 is a device for enabling the subject vehicle to conduct wireless communication with external devices. The external devices may include a server, a traffic information center, a roadside device, and some or all other vehicles. The wireless communication device 15 is configured to enable cellular communication. Cellular communication refers to wireless communication that complies with standards such as LTE (Long Term Evolution), 4G, or 5G. The wireless communication device 15 may also be configured to implement Cellular V2X (PC5/SideLink/Uu).

Additionally, the wireless communication device 15 is configured to enable short-range communication. In the present disclosure, short-range communication refers to wireless communication with a communication range limited to within a few hundred meters. The short-range communication methods used may include DSRC (Dedicated Short Range Communications) compliant with IEEE 802.11p, Wi-Fi (registered trademark), or Bluetooth (registered trademark) Low Energy. The short-range communication method may also be the aforementioned Cellular V2X. The wireless communication device 15 may be configured to perform data communication related to toll payment with a roadside unit installed at the gate when passing through the gate. For example, the wireless communication device 15 may be an on-board unit compatible with ETC 2.0.

The wireless communication device 15 may receive information about the gate point from an external device. For example, the wireless communication device 15 may receive information such as the location of gate points, passable gates, and blocked gates from a server or center. The wireless communication device 15 may receive vehicle information from surrounding vehicles through vehicle-to-vehicle communication. The vehicle information may include speed, current location, turn signal status, acceleration, movement trajectory, and other data. The surrounding vehicles mentioned here refer to vehicles that are within the range of vehicle-to-vehicle communication.

The occupant state sensor 16 is a sensor that detects the condition of the driver. The occupant state sensor 16 may be, for example, a Driver Status Monitor (hereinafter referred to as DSM). The DSM is a sensor that detects the driver's face orientation, gaze direction, eyelid openness, and other factors based on the driver's facial image. The DSM, as the occupant state sensor 16, is positioned on the instrument panel, the upper edge of the windshield, or similar locations such that it is oriented with its optical axis directed towards the driver's seat headrest, allowing it to capture images of the driver's face. The DSM, as the occupant state sensor 16, transmits driver status data indicating the driver's face orientation, gaze direction, eyelid openness, and other factors to the automated driving ECU 30. The occupant state sensor 16 may also be a pulse sensor, thermal camera, or similar device.

The body ECU 17 is an ECU that integrally controls the body-related in-vehicle devices installed in the vehicle. The body-related in-vehicle devices include lighting systems, horns, and door lock motors, for example. Lighting systems include headlights, hazard lamps, turn signals, backlights, and welcome lamps. The body-related in-vehicle devices may also include the external display device 18.

The external display device 18 is a projector that projects images onto the rear window. The external display device 18 can display images for communicating with drivers of other vehicles based on input signals from the automated driving ECU 30. For example, the external display device 18 displays images indicating the moving direction of the subject vehicle or images requesting the right of way (in other words, permission to merge) to the rear vehicle traveling in the adjacent lane. The external display device 18 is installed in a position where the projection light hits the rear window, such as on the ceiling of the vehicle interior (for example, near the upper end of the window frame).

The external display device 18 may also project onto the side windows or the road surface around the subject vehicle. The external display device 18 may be provided on the side mirrors to project images onto the road surface near the vehicle. The headlights or taillights may be configured to operate as the external display device 18. The external display device 18 may be a liquid crystal display or similar device arranged with the display surface facing the side or rear of the vehicle.

The in-vehicle HMI 20 is a group of interfaces for exchanging information between an occupant and the automated driving system Sys. The in-vehicle HMI 20 includes a display 21 and a speaker 22 as notification devices for conveying information to the driver. Additionally, the in-vehicle HMI 20 includes an input device 23 as an input interface for accepting operations from the occupant.

The automated driving system Sys includes, as the display 21, one or more of a head-up display (HUD), a meter display, and a center display. The HUD is a device that projects image light onto a predetermined area of the windshield, thereby displaying a virtual image that can be perceived by the driver. The meter display is a display positioned in the area directly in front of the driver's seat on the instrument panel. The center display is a display provided in the central part of the instrument panel in the vehicle's width direction. The meter display and center display can be implemented using a liquid crystal display or an organic light-emitting diode display. The display 21 shows images according to signals input from the automated driving ECU 30. The speaker 22 is a device that outputs sound corresponding to signals input from the automated driving ECU 30. The term “sound” in this disclosure includes notification sounds, voice, music, and the like.

The automated driving system Sys may also include other notification devices, such as a vibrator or ambient light. The ambient light is an illumination device realized by multiple LEDs (light emitting diodes), with adjustable emission colors and emission intensity. The ambient light is provided in the instrument panel, steering wheel, A-pillars, and the like. The A-pillar is the pillar located next to the windshield. The A-pillar can also be referred to as the front pillar.

The input device 23 is a device for receiving driver operation instructions for the automated driving system Sys. As the input device 23, a steering switch provided on the spoke part of the steering wheel, an operating lever provided on the steering column part, a touch panel overlaid on the center display, and the like can be adopted. The automated driving system Sys may include multiple types of devices as the input device 23.

The input device 23 outputs an operation signal, which is an electrical signal corresponding to the driver's operation, to the automated driving ECU 30. The operation signal includes information indicating the content of the driver's operation. The automated driving system Sys receives instructions related to changing the operation mode via the input device 23. The instructions related to changing the operation mode also include instructions for starting and ending automated driving. The automated driving system Sys may be configured to acquire various driver instructions through voice recognition. Devices related to voice input, such as a microphone, can also be included in the input device 23. Further, an HCU (HMI Control Unit) may be interposed between the in-vehicle HMI 20 and the automated driving ECU 30. The HCU is a device that integrally controls the information output (in other words, notifications) to the driver.

The automated driving ECU 30 is an ECU that executes some or all of the driving operations in place of the driver by controlling the driving actuator 19 based on detection results from the surrounding monitoring sensors 11 and other inputs. The automated driving ECU 30 is also referred to as an automatic operation device. The driving actuator 19 includes, for example, a brake actuator, an electronic throttle, and a steering actuator. The steering actuator includes an EPS (Electric Power Steering) motor. Other ECUs, such as a steering ECU for steering control, a power unit control ECU for acceleration and deceleration control, and a brake ECU, may be interposed between the automated driving ECU 30 and the driving actuator 19.

The automated driving ECU 30 is implemented using a computer equipped with a processor 31, memory 32, storage 33, communication interface 34, and a bus or other connections to link these components. The memory 32 is a rewritable volatile storage medium. The memory 32 is, for example, RAM (Random Access Memory). The storage 33 is, for example, a rewritable non-volatile memory such as flash memory. The storage 33 stores a vehicle control program, which is executed by the processor 31. The vehicle control program includes a notification control program for controlling notifications to the driver regarding gate passage. The execution of the notification control program by the processor 31 corresponds to the execution of a notification control method.

The automated driving ECU 30 is equipped with multiple operation modes with varying levels of automation. Each operation mode differs in the scope of driving tasks handled by the driver, in other words, the scope of driving tasks in which the system intervenes. The operation mode can be alternatively referred to as the driving mode. As an example, the automated driving ECU 30 is configured to switch between multiple operation modes, including at least a fully manual mode, a level 2 mode, and a level 3 mode.

The fully manual mode is an operation mode in which the driver performs all driving tasks. The fully manual mode corresponds to a mode in which the automated driving ECU 30 does not perform substantial vehicle control. The fully manual mode may also be a mode in which the operation of the automated driving ECU 30 is stopped (so-called stop mode). In the fully manual mode, the automated driving ECU 30 may continue to perform the recognition processing of the driving environment in the background (in other words, potentially) as a preparatory process for switching to the level 2 or level 3 mode.

The level 2 mode is an operation mode in which automated driving control with surrounding monitoring obligation is performed, in other words, vehicle control equivalent to the automation level 2. The level 2 mode can be referred to as a semi-automated driving mode or an eyes-on automated driving mode. The level 2 mode may be subdivided into a hands-on level 2 mode and a hands-off level 2 mode. In this embodiment, the hands-on level 2 mode of the automated driving ECU 30 is a mode that requires the driver to hold the steering wheel. The hands-off level 2 mode is an operation mode that does not require the driver to hold the steering wheel, in other words, it is an operation mode that allows hands-off driving. In this disclosure, hands-on refers to holding the steering wheel. Hands-off refers to the act of removing one's hands from the steering wheel. Eyes-on refers to monitoring the area outside the subject vehicle related to the direction of its movement (primarily the frontward direction). Eyes-off refers to the act of looking away from the area outside the subject vehicle related to the direction of its movement.

The level 3 mode is an operational mode that performs automated driving control without the obligation of monitoring the surroundings, equivalent to the automation level 3 vehicle control. The automated driving ECU 30 may be capable of implementing automated driving control equivalent to level 4 or higher. The level 3 mode can be referred to as automated driving mode or eyes-off automated driving mode. The automated driving ECU 30 may be equipped with multiple processors 31. The processor that executes level 3 or higher automated driving control may be provided separately from the processor that executes level 2 or lower vehicle control.

The automated driving ECU 30 automatically performs steering, acceleration, and deceleration (in other words, braking) of the subject vehicle so that the subject vehicle travels along the planned route towards the destination set by the driver while in automated driving mode. The automated driving ECU 30 may continue automated driving by selecting routes to keep traveling or circulating within the range that satisfies the ODD, even if a destination is not set.

The ODD may include conditions such as (a) the roadway being a highway or a dedicated road for automobiles equipped with a median strip and guardrails, (b) the rainfall amount being below a specified threshold, and (c) the presence of traffic congestion. Here, the dedicated road for automobiles refers to roads where the entry of pedestrians and bicycles is prohibited, including, for example, toll roads such as highways. Additionally, the traffic congestion refers to a condition where the travel speed is below a congestion determination value (for example, around 30 km/h) and other vehicles are present within a specified distance (for example, 20 meters) in front of and behind the subject vehicle. Furthermore, the ODD may also include conditions such as (d) all or a specified number of surrounding monitoring sensors 11 functioning correctly, and (e) the absence of parked vehicles on the road. The conditions for determining whether automated driving is possible or not, in other words, the detailed conditions defining the ODD, can be modified as necessary.

Additionally, the automated driving ECU 30 performs control for autonomous driving of the vehicle even while in the Level 2 mode. In other words, it performs the recognition of the driving environment, planning of the driving trajectory, and reflection/feedback into the control. Reflection into the control includes speed adjustments through acceleration and deceleration, as well as steering control. Unless otherwise noted, any mention of automated driving hereinafter can be replaced with Level 2 equivalent semi-automated driving.

In automated driving mode, the automated driving ECU 30 allows the driver to engage in secondary tasks. The secondary tasks permitted in Level 3 automated driving can be limited to activities such as reading or using a smartphone, which allow the driver to quickly resume control of the vehicle if necessary. The automated driving mode can be terminated due to driver steering/pedal operations (so-called override), system limitations, or exiting the ODD, among other reasons.

### Configuration of the Automated Driving ECU

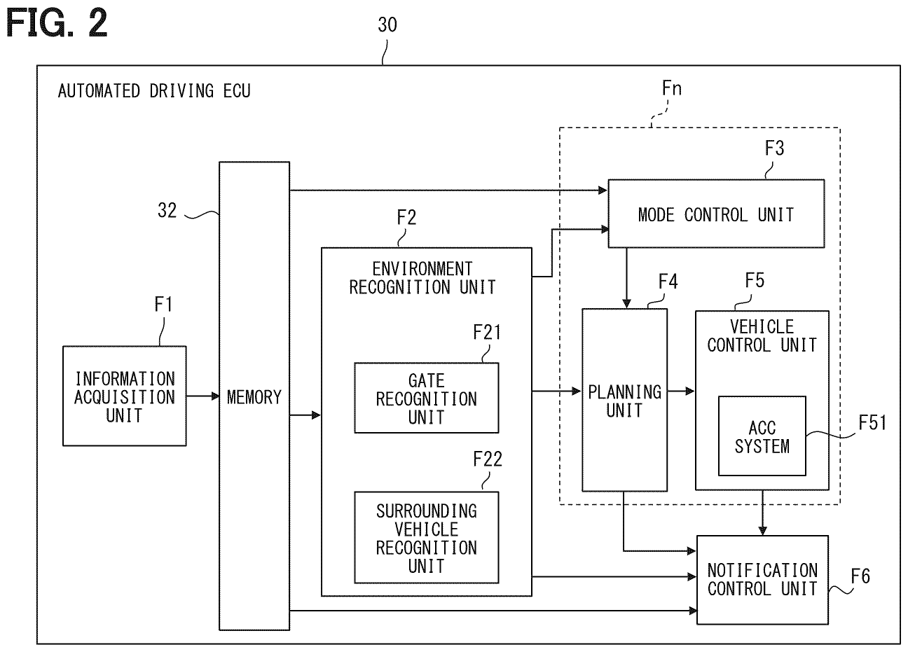

The automated driving ECU 30 includes functional units, as shown in FIG. 2, which are realized by executing the automated driving program. In other words, the automated driving ECU 30 comprises an information acquisition unit F1, an environment recognition unit F2, a mode control unit F3, a planning unit F4, a vehicle control unit F5, and a notification control unit F6.

The information acquisition unit F1 acquires various types of information necessary for implementing vehicle control such as automated driving and driving assistance. The information acquisition unit F1 obtains sensing data (i.e., detection results) from the various surrounding monitoring sensors 11, including the camera 111. The sensing data includes information about objects present around the subject vehicle, such as moving objects, landmarks, and obstacles. The data for each detected object may include the position, movement speed, and its type or size.

The sensing data related to landmarks may include data on the detection results of lane lines and road edges. The data for lane lines may include not only position data but also line type data. The line type can be represented as either a solid line (continuous line) or a dashed line. The sensing data may also include data indicating the recognition status of lane lines, such as whether the lane lines are recognized, and the recognition status of road edges, such as whether the road edges are recognized.

Additionally, the information acquisition unit F1 obtains data indicating the vehicle's status from the vehicle state sensor 12, such as the subject vehicle's speed, acceleration, yaw rate, and external illumination. Furthermore, the information acquisition unit F1 acquires the subject-vehicle position data from the locator 13. The information acquisition unit F1 acquires the surrounding map information by referring to the map storage unit 14.

The information acquisition unit F1 acquires data transmitted from external devices using the wireless communication device 15. For example, the information acquisition unit F1 can acquire vehicle information transmitted from the forward vehicle via vehicle-to-vehicle communication. Additionally, the information acquisition unit F1 acquires dynamic map data for the road segments that the subject vehicle is scheduled to pass through within a predetermined time, in collaboration with the wireless communication device 15. The dynamic map data here includes traffic congestion information, merging vehicle information, and other relevant data.

The information acquisition unit F1 also acquires information on driver operations with respect to the automated driving system Sys based on signals from the input device 23. For example, the information acquisition unit F1 obtains instruction signals related to the start and end of automated driving from the input device 23. Additionally, the information acquisition unit F1 acquires data related to the operational status of the automated driving system Sys from various devices and software modules. For example, the information acquisition unit F1 also acquires data such as the operational status (on/off) of the ACC function and whether or not a preceding vehicle is recognized. Furthermore, the information acquisition unit F1 manages the operational status of various components, such as whether the surrounding monitoring sensors 11 are functioning properly. The information acquisition unit F1 acquires driver status data, such as the degree of eye openness and the direction of the line of sight, from the occupant state sensor 16.

The various data sequentially acquired by the information acquisition unit F1 are stored in a temporary storage medium, such as the memory 32, and are utilized by components such as the environment recognition unit F2 and the mode control unit F3. Additionally, the various types of information can be categorized and stored in the memory 32 according to their respective types. Furthermore, the various types of information can be sorted and stored such that, for example, the most recent data is at the beginning. Data that has exceeded a certain period of time since acquisition may be discarded. In the present disclosure, “acquisition” also includes the generation, detection, and determination performed by the automated driving ECU 30 based on calculations by the automated driving ECU 30 using data input from other devices or sensors. This is because the functional configuration within the system can be modified as necessary.

The environment recognition unit F2 recognizes the driving environment of the subject vehicle based on various data acquired by the information acquisition unit F1. The environment recognition unit F2 may recognize the driving environment of the subject vehicle through sensor fusion processing, which integrates detection results from multiple surrounding monitoring sensors 11, such as the camera 111 and the millimeter wave radar 112, with predetermined weights.

The driving environment includes the curvature of the road, the number of lanes, the subject-vehicle lane number, the weather, the road surface conditions, the traffic volume, and the remaining distance to the gate point. The subject-vehicle lane number is a number indicating the position of the subject-vehicle lane on the road, determined with reference to the left edge of the road. The subject-vehicle lane number directly or indirectly indicates the number of lanes to the left of the subject-vehicle lane. Of course, the subject-vehicle lane number may also be expressed with reference to the right edge of the road. The subject-vehicle lane number may be identified using the distance from the edge of the road to the subject vehicle, the number of lane lines detected on the left and right, and some or all of the map data. The subject-vehicle lane number may be identified from the map data and the subject-vehicle position data. The identification of the subject-vehicle lane number may be carried out by the camera 111 or the locator 13. The weather and road conditions can be identified by combining the recognition results of the camera 111 with the weather information obtained by the information acquisition unit F1. In addition to the recognition results of the camera 111, the road structure may be identified using map data or the trajectory information of the forward vehicle.

The environment recognition unit F2 acquires information related to the structure of the road within a predetermined distance ahead of the subject vehicle based on at least one of the output signals from the surrounding monitoring sensors 11, the reception signals from external devices, and the map data. The road structure includes the position of gate points, the position of branch roads, the number of lane lines, the road width, and so on. The environment recognition unit F2 acquires the remaining distance to the gate points as detailed information regarding the gate points. The remaining distance to the gate points may be acquired based on map data or identified based on the data of guide signs detected by the camera 111. The environment recognition unit F2 may also identify the remaining distance to the gate points based on behavior data or sensing data received from the forward vehicle. The environment recognition unit F2 may acquire the number of gates and the payment method for each gate from the map data or the travel trajectory of the forward vehicle. The environment recognition unit F2 may regard gates that require stopping as manual payment gates, and gates that the forward vehicle passes through without stopping as automatic payment gates. In the environment recognition unit F2, a functional unit configured to acquire information related to gate points corresponds to a gate recognition unit F21.

The driving environment includes the position, type, and moving speed of objects present around the subject vehicle. The environment recognition unit F2 recognizes the positions and behaviors of surrounding vehicles based on various data acquired by the information acquisition unit F1. The software/hardware module responsible for the process of recognizing surrounding vehicles corresponds to a surrounding vehicle recognition unit F22. As the surrounding vehicle recognition unit F22, the environment recognition unit F2 can calculate the collision risk for each detected vehicle. The collision risk may be represented by, for example, TTC (Time-To-Collision) or MTC (Margin-To-Collision). For example, the environment recognition unit F2 calculates the TTC (Time-To-Collision) for each vehicle. TTC and MTC are parameters where smaller values indicate a higher collision risk. Additionally, the environment recognition unit F2 acquires external environment information related to the ODD, and the driver status data.

The mode control unit F3 controls the operating mode of the automated driving ECU 30 based on various types of information acquired by the information acquisition unit F1. The switching of operating modes is executed based on operation signals input from the input device 23. For example, if the driving environment satisfies the ODD and an automated driving start instruction signal is input from the input device 23, the mode control unit F3 switches the operating mode from the fully manual mode or the level 2 mode to the automated driving mode. Additionally, during the automated driving mode, if it is anticipated that the driving environment recognized by the environment recognition unit F2 will no longer satisfy the ODD, the mode control unit F3 may decide to transition to the fully manual mode and notify the planning unit F4 accordingly.

Furthermore, when an override operation by the driver is detected during the automated driving mode or level 2 mode, the mode control unit F3 switches to the fully manual mode. The override operation refers to the occupant's operation of driving control elements such as the steering wheel, brake pedal, and accelerator pedal. When the automated driving ECU 30 detects that the override operation has been performed by the driver, it promptly transfers driving authority to the driver and notifies that the mode has switched to manual driving through audio output or other means. The operating mode transitioned to at the end of the automated driving mode may be the level 2 mode.

The planning unit F4 is configured to plan the control content to be executed as level 2 or higher automated driving. The planning unit F4 can be activated when the operating mode is either level 3 or level 2 mode. While in level 3 or level 2 mode, the planning unit F4 generates a driving plan for automated driving based on the recognition results of the driving environment by the environment recognition unit F2. The driving plan can also be referred to as a control plan. The planning unit F4 corresponds to a configuration that creates a driving plan for the vehicle. The driving plan includes the driving position at each time, target speed, steering angle, and other parameters. That is, the driving plan may include schedule information for acceleration and deceleration to adjust the speed on the calculated route, as well as schedule information for the steering amount.

For example, the planning unit F4 performs route search processing as a medium-to-long-term driving plan and determines the planned driving route from the current subject-vehicle position to the destination. If a destination is not set, the planning unit F4 may select a route on which automated driving can continue as the planned driving route. The planned driving route includes data on the roads that will be traveled within a predetermined time (for example, 10 minutes).

The planning unit F4 generates a short-term control plan for driving in accordance with the medium-to-long-term driving plan, such as a driving plan for lane change, a driving plan for driving in the center of the lane, a driving plan for following a preceding vehicle, and a driving plan for obstacle avoidance. For example, the planning unit F4 may generate as the short-term control plan a driving route that follows the center of the recognized subject-vehicle lane, or generate a driving route that follows the behavior or driving trajectory of the recognized preceding vehicle. The control plan created by the planning unit F4 is input to the vehicle control unit F5.

The planning unit F4 executes gate passage planning processing as a function related to passing through gate points. The gate passage planning processing includes setting the target gate, generating the travel trajectory to the target gate, and generating the trajectory after passing through the gate. The target gate is the gate through which the subject vehicle will pass among the multiple gates provided at the gate point. The method for setting the target gate will be described separately later.

In addition to control planning directly related to vehicle travel, the planning unit F4 also formulates a plan related to notification processing for passengers using notification devices such as the display 21. For example, the planning unit F4 plans the timing for executing pre-notifications/requests to the driver, such as behavior pre-notification, mode change notification, eyes-on request, hands-on request, and Take Over Request (TOR) pre-notification. The behavior pre-notification is the process of notifying the driver of anticipated vehicle behaviors such as lane changes, overtaking, and deceleration. The mode change notification is the process of informing the driver that the operation mode is being changed or is scheduled to be changed.

The eyes-on request is the process of requesting the driver to monitor the surroundings as a precaution while in the level 3 mode. The hands-on request is the process of asking the driver to lightly grasp the steering wheel while in the level 3 mode or hands-off level 2 mode. The TOR pre-notification is the process of informing the driver that the likelihood of a Take-Over Request (TOR) is increasing. The TOR is the process of requesting the driver to take over the driving operation, in other words, to terminate automated driving.

Various notifications, including pre-notifications and requests, include displaying an icon image corresponding to their content on the display 21. The various notifications may involve some or all of the following: output of a notification sound, output of a voice message, flashing of an ambient light, and/or vibration of a vibrator depending on their importance and urgency. The planning unit F4 creates notification planning data that indicates the content of the notification and the timing at which the notification is to be made, and sends this data to the notification control unit F6.

The vehicle control unit F5 generates control commands based on the control plan formulated by the planning unit F4 and sequentially outputs them to the driving actuators 19. Additionally, the vehicle control unit F5 also controls the lighting status of the direction indicators, headlights, hazard lights, etc., based on the plans of the planning unit F4 and the external environment, in accordance with the driving plan and external conditions.

The vehicle control unit F5 includes an ACC system F51 as a subsystem for executing preceding-vehicle following control. The ACC system F51 executes the preceding-vehicle following control based on the plan created by the planning unit F4. In other words, the ACC system F51 controls the vehicle speed to maintain a constant distance/time gap with the preceding vehicle within the range of the set speed when the preceding vehicle is recognized. Additionally, the ACC system F51 adjusts the speed to be maintained at the set speed when the preceding vehicle is not recognized or when the speed of the preceding vehicle exceeds the set speed. The ACC system F51 provides data indicating the recognition status of the preceding vehicle and the implementation status of the preceding-vehicle following control to the notification control unit F6. The ACC system F51 can also be referred to as a preceding-vehicle following control unit.

The software/hardware modules, including the mode control unit F3, the planning unit F4, and the vehicle control unit F5, correspond to an automated driving unit Fn. The information acquisition unit F1 and the environment recognition unit F2 can also be included in the automated driving unit Fn.

The notification control unit F6 is a subsystem for notification/suggesting to the driver using notification devices such as the display 21 and the speaker 22. Various notifications/suggestions can be implemented by displaying images on the display 21 or outputting voice messages from the speaker 22. The notification control unit F6 executes various notifications based on the planning of the planning unit F4.

The notification control unit F6 also obtains data related to the relative position of the subject vehicle with respect to the gate point as a recognition result of the environment recognition unit F2. For example, the notification control unit F6 obtains information such as whether the subject vehicle has entered the gate area, the remaining distance to the target gate, whether the target gate has been passed, and whether the subject vehicle has exited the gate area. Additionally, the notification control unit F6 also obtains the positions of surrounding vehicles, the operational status of the preceding-vehicle following control, the recognition status of the preceding vehicle, and the current operating mode. The processor 31 of the notification control unit F6 performs gate approach response processing when passing through a gate. The gate approach response processing will be described later separately.

In this embodiment, the notification control unit F6 is configured to selectively adopt two levels of notification modes for notifications such as eyes-on requests: a conspicuous mode and a subtle mode. The subtle mode refers to a mode in which stimuli such as light and sound are reduced compared to the conspicuous mode. The subtle mode refers to a notification mode aimed at not causing annoyance to the occupants. Notification in the subtle mode refers to a notification that mainly involves image display, without applying vibration to the driver, and with the output volume of the notification sound set to a predetermined level or lower. Setting the output volume to a predetermined level or lower includes not outputting any sound at all. The subtle mode can also be referred to as an inconspicuous mode.

Notification in the conspicuous mode refers to a notification intended to ensure that the driver firmly recognizes the content. Notification in the conspicuous mode may include the output of voice messages or sound effects at a volume level above a predetermined level. Notification in the conspicuous mode may also involve the application of vibrations to the driver. The conspicuous mode corresponds to outputting stimuli of sufficient intensity necessary to capture the driver's attention.

### Setting of Target Gate

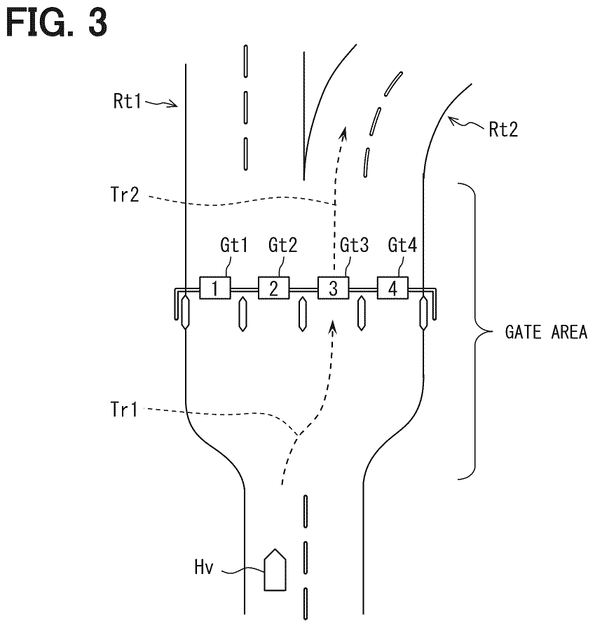

The method for setting the target gate will be described here with reference to FIG. 3. The road shown in FIG. 3 is equipped with four gates at one gate point and has a structure that branches into a first road Rt1 and a second road Rt2 behind the gate point.

As shown in FIG. 3, when multiple gates are installed at the gate point, the processor 31, functioning as the planning unit F4, sets a gate corresponding to a post-gate road as the target gate among the multiple gates. The post-gate road is a road on which the subject vehicle is scheduled to travel after passing through the gate point. The gate corresponding to the post-gate road refers to a gate located directly before the post-gate road, in other words, a gate that allows entry onto the post-gate road by driving straight ahead after passing through the gate. The gate corresponding to the post-gate road can be understood as a gate leading to the post-gate road. From the opposite perspective, a road corresponding to a certain gate can be understood as a road located directly behind the gate, a road closest to the gate, or a road continuing from the gate along a road edge closest to the gate.

In the example shown in FIG. 3, a first gate Gt1 and a second gate Gt2 are gates corresponding to the first road Rt1. Additionally, a third gate Gt3 and a fourth gate Gt4 correspond to gates corresponding to the second road Rt2.

The processor 31 may set a gate closest to an extension line of the current subject-vehicle lane as the target gate if there are multiple gates corresponding to the post-gate road. For example, if the second road Rt2 is the post-gate road for the subject vehicle and the current subject-vehicle lane is the first lane, the processor 31 will set the third gate Gt3 as the target gate. This is because the third gate Gt3 is closer to the subject-vehicle lane than the fourth gate Gt4 is. “Hv” in FIG. 3 denotes the code indicating the subject vehicle. The processor 31 sets the target gate so that the amount of lateral movement after passing through the gate is minimized.

Of course, if the third gate Gt3 meets a specific non-use condition, the processor 31 may set the fourth gate Gt4 as the target gate instead of the third gate Gt3. The non-use condition is met, for example, when the gate is blocked, when the payment method is manual, or when the third gate Gt3 is more crowded than the fourth gate Gt4. The target gate selection algorithm may be modified as appropriate.

The processor 31 may select the target gate from among gates capable of automatic payment. Furthermore, if the subject vehicle is unable to perform automatic payment processing, the processor 31 may select the target gate from among the gates capable of manual payment. The inability to perform automatic payment processing refers to situations such as when the card for automatic payment is not inserted into a designated onboard device. If there is only one gate through which the subject vehicle can pass in terms of payment methods or other considerations, the processor 31 may set that gate as the target gate.

If there is only one gate available due to closures or other restrictions, the processor 31 may also set that gate as the target gate. Additionally, if no destination is set, the processor 31 may set the gate located in the extension line of the subject-vehicle lane as the target gate. Furthermore, if no destination is set, the processor 31 may set a road that can maintain the level 3 mode as the post-gate road and then set a gate corresponding to the post-gate road as the target gate. If there is no gate through which the vehicle can pass while maintaining automated driving, the notification control unit F6 may execute the TOR.

Once the target gate is set, the processor 31 creates a pre-gate trajectory and a post-gate trajectory based on the position of the target gate, the current position of the subject vehicle, and the position of a planned driving lane on the post-gate road. The pre-gate trajectory is a trajectory leading up to the entry of the target gate. The post-gate trajectory is a trajectory from the exit of the target gate to the entry onto the post-gate road. The pre-gate trajectory may include a route change (such as a lane change) towards the target gate. In FIG. 3, the broken line indicated by “Tr1” conceptually represents the pre-gate trajectory, while the broken line indicated by “Tr2” conceptually represents the post-gate trajectory.

When the subject vehicle is on the front side (entry side) of the gate, it is difficult to detect objects that exist behind the gate. If the target gate is set such that the lateral movement amount after passing through the gate is greater than the lateral movement amount before passing through the gate, the control difficulty after passing through the gate will increase. This is because there may be obstacles that were not detected before passing through the gate. In other words, the likelihood of overlooking surrounding vehicles is smaller before passing through the gate than after passing through the gate. By setting the target gate such that the lateral movement amount before passing through the gate is greater than or equal to the lateral movement amount after passing through the gate, safety can be enhanced. This configuration corresponds to a function that sets the target gate so that the lateral movement amount after passing through the gate is minimized.

The target gate and trajectory data near the gate set by the processor 31, functioning as the planning unit F4, can be referenced not only by the vehicle control unit F5 but also by the notification control unit F6.

### Gate Approach Response Processing

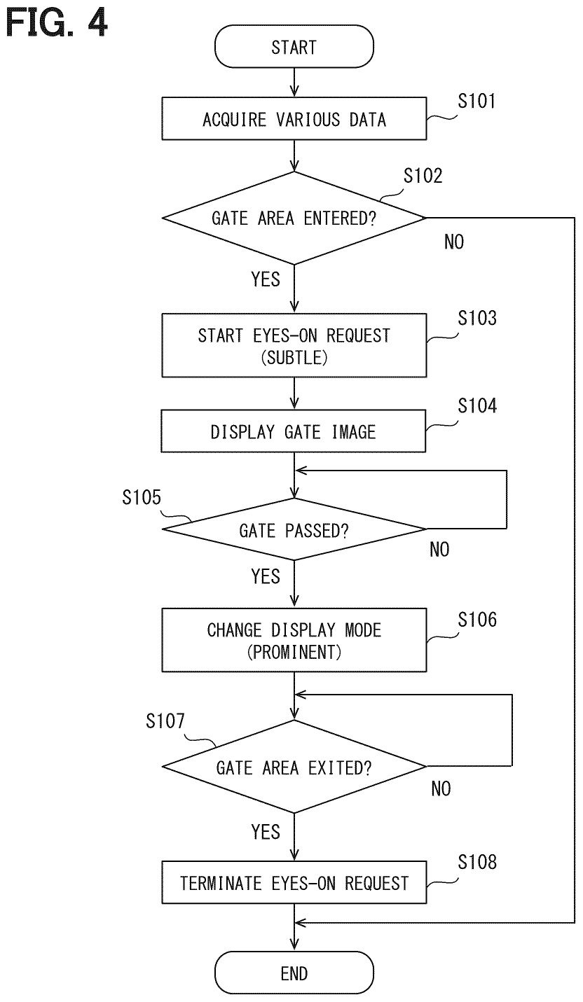

Here, the gate approach response processing executed by the notification control unit F6 will be explained with reference to the flowchart shown in FIG. 4. The flowchart shown in FIG. 4 can be executed periodically while in the level 3 mode. As an example, the flowchart shown in FIG. 4 includes steps S101 to S108.

Step S101 is a step where the notification control unit F6 acquires data indicating the relative position of the subject vehicle with respect to the gate point. The processing in step S101 is also periodically executed after step S103. Step S101 may also include step of acquiring the current operating mode of the automated driving ECU 30, as well as step of acquiring data indicating a planned driving trajectory created by the planning unit F4. Step S101 can be understood as a step where the notification control unit F6 acquires the necessary data to carry out various notifications.

Step S102 is a step where it is determined whether the subject vehicle has entered the gate area. As mentioned above, the gate area may be a road section that is within a certain distance from the gate point. The distance considered as the gate area may be 100 meters, 250 meters, 400 meters, or the like. In the configuration where the section within a certain distance from the gate point is defined as the gate area, step S102 can be understood as a step where it is determined whether the remaining distance to the gate point has become less than or equal to a predetermined value. As criteria for determining the remaining distance to the gate point, outputs from the surrounding monitoring sensors 11, data received from external devices, and map data, as mentioned above, can be employed. Additionally, the gate area may be, in another embodiment, a lane-free section. In the configuration where the gate area is considered to be a lane-free section near the gate, the notification control unit F6 can determine that the subject vehicle has entered the gate area based on the camera 111 no longer detecting lane lines. Additionally, the gate area may be a region where the road width is expanded near the gate point. Whether the subject vehicle has entered the gate area may be determined using the subject vehicle's position on the map. The determination of entry into the gate area may be carried out using various methods.

When the subject vehicle has entered the gate area (S102 YES), the processor 31 executes the subsequent sequence starting from step S103. On the other hand, when the subject vehicle has not entered the gate area (S102 NO), this flow is terminated. When this flow is terminated, the flow may be re-executed after a predetermined idle time has elapsed from the termination point. The idle time may be set, for example, to 500 milliseconds, 1 second, 2 seconds, or the like.

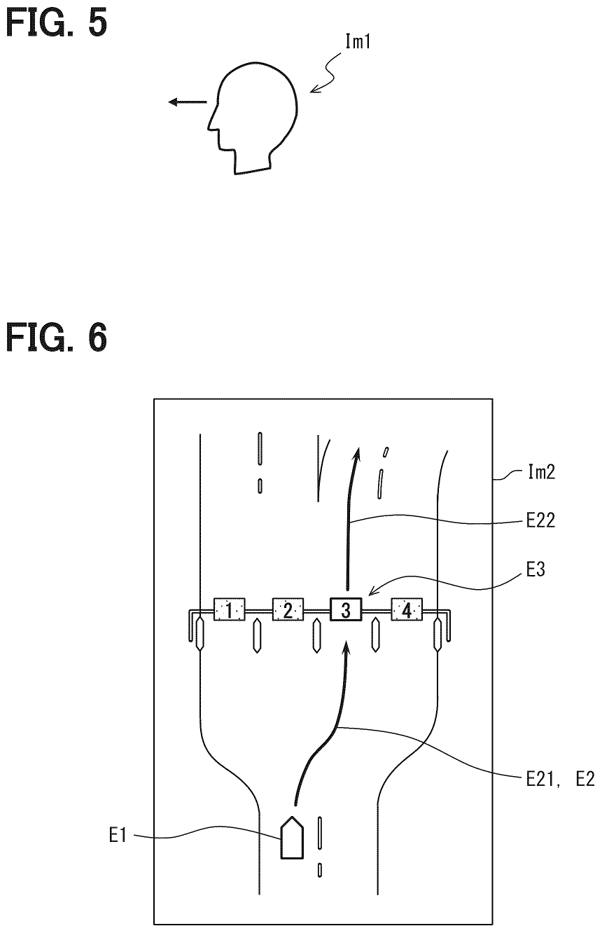

Step S103 is a step in which an eyes-on request is executed. Step S103 corresponds to a step in which the system requests the driver to check the surrounding situation based on the fact that the vehicle has entered the gate area. By implementing the eyes-on request, it becomes easier for the driver to take over the driving operations. The eyes-on request includes displaying an eyes-on icon Im1, as illustrated in FIG. 5, at a predetermined position on the display 21. The eyes-on icon Im1 is an icon image/pictogram that simulates the driver looking ahead. The eyes-on request may be accompanied by output of a predetermined notification sound or turning on of an ambient light.

The notification control unit F6 of the present embodiment implements the eyes-on request in the subtle mode in the pre-gate area. The subtle eyes-on request may involve displaying the eyes-on icon Im1 in green or yellow, for example. The subtle eyes-on request may also involve displaying the eyes-on icon Im1 at a predetermined size in the corner of the display 21. The display of the eyes-on icon Im1, which requests eyes-on, may continue until reaching the front of the target gate.

Upon executing step S103, the notification control unit F6 performs step S104, displaying a gate guidance image Im2 on the display 21. The gate guidance image Im2 is an image that represents the road structure near the gate. The gate guidance image can also be understood as a map image of the area near the gate. The gate guidance image may include an image indicating the trajectory of the subject vehicle near the gate.

For example, as shown in FIG. 6, the gate guidance image Im2 includes image elements such as a subject vehicle image E1, a pre-gate trajectory image E21, a post-gate trajectory image E22, and a gate image E3. The subject vehicle image E1 is an image element that represents the position of the subject vehicle. The pre-gate trajectory image E21 is an image element that represents the trajectory from the current position to the target gate. The post-gate trajectory image E22 is an image element that represents the trajectory of the subject vehicle after passing through the target gate. The gate image E3 is an image that indicates the position of the target gate. The gate image E3 may include not only the image of the target gate but also images of other gates. The gate image E3 may be an image of multiple gates installed at the gate point. In the gate image E3, the target gate may be displayed in a manner different from the other gates. For example, gates other than the target gate may be grayed out. The target gate may have effects or decorations such as blinking. According to this configuration, it becomes easier for the driver to recognize the position of the target gate.

The pre-gate trajectory image E21 and the post-gate trajectory image E22 are represented by arrows, for example. The pre-gate trajectory image E21 and the post-gate trajectory image E22 may be bands, belts, or lines representing the trajectory. The pre-gate trajectory image E21 and the post-gate trajectory image E22 may be connected. The pre-gate trajectory image E21 and the post-gate trajectory image E22 are collectively referred to as a trajectory image E2. If the trajectory image E2 overlaps with the gate image E3, the visibility of the target gate may deteriorate. Therefore, it is preferable that the trajectory image E2 is interrupted before the gate so that it does not overlap with the gate image E3. As illustrated in the gate guidance image Im2 in FIG. 6, by displaying the trajectory image E2 divided into the pre-gate trajectory image E21 and the post-gate trajectory image E22, the driver can more easily confirm the target gate.

Additionally, according to the configuration in which the gate guidance image Im2 includes both the pre-gate trajectory image E21 and the post-gate trajectory image E22, the driver can more easily recognize the overall behavior of the subject vehicle as it passes through the gate. The gate area is a region where the difficulty of control is higher compared to a straight road. By visualizing the behavior plan of the automated driving ECU 30 in the gate area, the driver can assess the validity and feasibility of the plan. If the driver judges that the plan of the automated driving ECU 30 is reckless, the driver can override it without waiting for a request from the system.

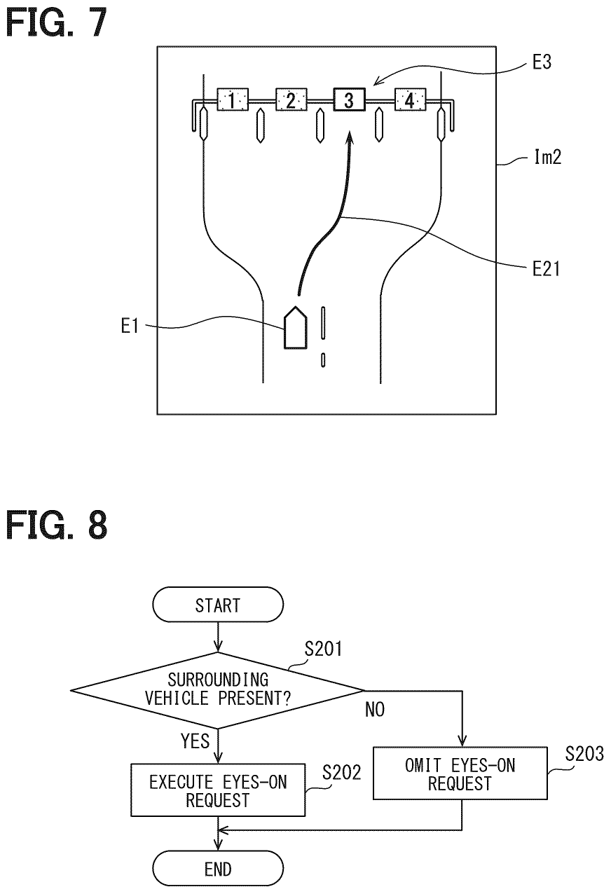

The post-gate trajectory image E22 is an optional element in the gate guidance image Im2. The gate guidance image Im2 may be an image that shows the behavior up to the point before entering the gate, as illustrated in FIG. 7. However, as exemplified in FIG. 6, according to the configuration that additionally displays the road shape of the post-gate road or the post-gate trajectory, the driver can be notified in advance of the movement of the subject vehicle after passing through the gate. The direction/objects that the driver should pay attention to may differ depending on the trajectory after passing through the gate, for example, whether the vehicle travels straight, diagonally right, or diagonally left. According to the configuration that displays the gate guidance image Im2, which includes the post-gate trajectory image E22, it becomes easier for the driver to pay attention to the appropriate direction.

The gate guidance image Im2 does not need to be an image that looks down on the road from above (a so-called bird's-eye view image). The gate guidance image Im2 may also be a three-dimensional image from the driver's perspective. Additionally, the gate guidance image Im2 may be an image viewed from a virtual viewpoint positioned above the vehicle, looking at the target gate. Furthermore, the gate guidance image Im2 may be displayed on a head-up display so that it overlaps with the real scenery in front of the vehicle. The notification control unit F6 may superimpose the pre-gate trajectory image E21 and an image indicating the target gate onto the front scenery as the gate guidance image Im2. The display of the gate guidance image Im2 may continue until the vehicle passes through the gate or exits the gate area.

Step S105 is a step for determining whether the gate has been passed. Whether the gate has been passed may be determined based on the subject-vehicle position data on the map, the recognition results from the surrounding monitoring sensors 11, and the communication status with external devices. When the subject vehicle has passed through the gate (S105 YES), the notification control unit F6 changes the display mode of the eyes-on icon Im1 to the conspicuous mode in step S106. For example, the notification control unit F6 changes the color of the eyes-on icon Im1 to a highlight color such as red or orange. The highlighting of the eyes-on icon Im1 may be achieved by blinking, increasing the display size, or changing the display position.

Step S106 corresponds to a step of re-notifying the eyes-on request. Additionally, step S106 can be understood as step of implementing the eyes-on request in a more conspicuous manner compared to before passing through the gate. After passing through the gate, the trajectories of vehicles are more likely to intersect compared to before passing through the gate. As a result, the likelihood of other vehicles excessively approaching the subject vehicle increases. By re-issuing the eyes-on request after passing through the gate, the likelihood of the driver conducting surrounding monitoring can be increased. Consequently, the possibility of contact with other vehicles in the post-gate area can be further reduced.

Furthermore, the eyes-on request in the conspicuous mode may be accompanied by output of a notification sound, display of a text message requesting eyes-on, or generation of vibration. The display of the eyes-on icon Im1 may be continued until the exit of the gate. The notification control unit F6 executes step S107 when it executes/starts the eyes-on request in the conspicuous mode.

Step S107 is a step for determining whether the subject vehicle has exited the gate area. Similar to step S102, this determination can also be carried out based on various types of data. When the subject vehicle has exited the gate area (S107 YES), the notification control unit F6 terminates the eyes-on request (S108). The termination of the eyes-on request corresponds to, for example, cancellation of the display of the eyes-on icon Im1.

The above description pertains to an embodiment in which the eyes-on request is implemented while the vehicle is traveling in the pre-gate area, but it is not limited to this. The eyes-on request in the pre-gate area may be omitted. Conversely, the notification control unit F6 may implement the eyes-on request in the pre-gate area, while omitting the eyes-on request after passing through the gate. The notification control unit F6 may terminate the eyes-on request at the timing of passing through or entering the gate.

Additionally, it is also an optional control to change the intensity of the eyes-on request before and after passing through the gate. The notification control unit F6 may implement the eyes-on request in the same manner after passing through the gate as before passing through the gate.

As long as the automated driving ECU 30 is in the level 3 mode (i.e., automated driving mode), the driver's eyes-on is an optional element and not mandatory. Even during automated driving, it is expected that safety can be further enhanced by having the notification control unit F6 request the driver's eyes-on as an optional precautionary measure. Additionally, even while in the level 3 mode, by implementing the eyes-on request as the vehicle approaches a gate, the transition of driving operations can be smoother if it becomes necessary to switch from the level 3 mode to the hands-on level 2 mode.

### Supplementary Conditions for Implementing Eyes-On Request

The notification control unit F6 may adjust whether to implement the eyes-on request based on the presence of surrounding vehicles, as shown in FIG. 8, while the subject vehicle is traveling in automated driving mode within the gate area. Step S201 shown in FIG. 8 is a step for determining whether a surrounding vehicle is present. The surrounding vehicle here refers to another vehicle that is within a predetermined distance (for example, 100 meters) from the subject vehicle. Additionally, the surrounding vehicle may be limited to another vehicle whose TTC, calculated by the environment recognition unit F2 or similar, is less than a predetermined value (for example, 5 seconds). The presence of surrounding vehicles can be determined based on the recognition results of the environment recognition unit F2, and consequently, on the detection results of the surrounding monitoring sensors 11 or data received from external devices.

The notification control unit F6 executes an eyes-on request in step S202 when a surrounding vehicle is present (S201 YES). On the other hand, the notification control unit F6 decides to omit or postpone the eyes-on request in step S203 when no surrounding vehicle is present (S201 NO). The flowchart shown in FIG. 8 may be executed periodically while driving in the gate area in the level 3 mode until the eyes-on request is carried out.

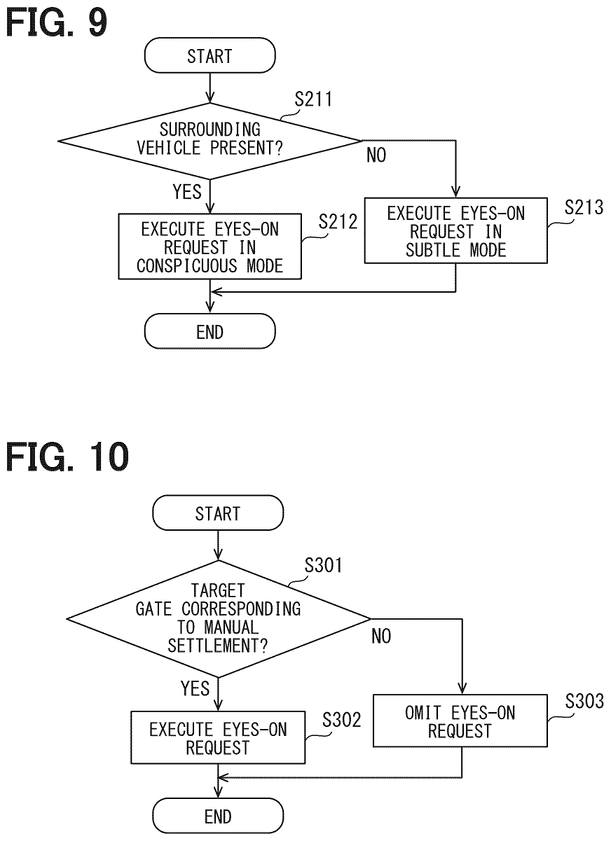

Additionally, as shown in FIG. 9, the notification control unit F6 may change the notification mode (intensity) of the eyes-on request depending on the presence or absence of the surrounding vehicle. For example, when a surrounding vehicle is present (S211 YES), the notification control unit F6 executes the eyes-on request in the conspicuous mode (S212). On the other hand, when no surrounding vehicle is present (S211 NO), the notification control unit F6 executes the eyes-on request in the subtle mode (S213).

According to the control examples shown in FIGS. 8 and 9, it is possible to enhance safety while reducing the risk of causing annoyance to the driver.

The determination process in step S201 may be replaced with a determination process of whether there is another vehicle with a collision risk above a predetermined value. The notification control unit F6 may be configured to execute the eyes-on request when there is another vehicle with a collision risk above a predetermined value while driving in the gate area, and to omit the eyes-on request when there is no such vehicle. The determination process in step S201 may be replaced with a determination process of whether there is a preceding vehicle. The determination process in step S201 may be replaced with a determination process of whether there is another vehicle diagonally ahead of the subject vehicle, in other words, whether there is another vehicle that may cut in front of the subject vehicle.

The determination process in step S211 may also be replaced with a determination process of whether there is another vehicle with a collision risk above a predetermined value, whether there is a preceding vehicle, or whether there is another vehicle diagonally ahead of the subject vehicle. The eyes-on request condition, which is a condition for executing the eyes-on request, may include the above sub-conditions in addition to driving in the gate area. The above sub-conditions refer to the presence of a surrounding vehicle, the presence of another vehicle with a collision risk above a predetermined value, the presence of a preceding vehicle, or the presence of another vehicle that may cut in front of the subject vehicle.

The strong request condition, which is a condition for executing the eyes-on request in the conspicuous mode, may similarly include any of the above sub-conditions in addition to driving in the gate area. Conversely, the notification control unit F6 may be configured to execute the eyes-on request in a more subtle manner than usual if the subtle request condition, which is a condition for executing the eyes-on request in the subtle mode, is satisfied. The subtle request condition may be any of the following: the absence of a surrounding vehicle, the absence of another vehicle with a collision risk above a predetermined value, the absence of a preceding vehicle, or the absence of another vehicle that may cut in front of the subject vehicle.

Additionally, the notification control unit F6 may change whether to execute the eyes-on request according to the settlement method of the target gate, as shown in FIG. 10. Step S301 shown in FIG. 10 is a step for determining whether the target gate corresponds to a manual settlement method. The settlement method that the target gate corresponds to can be identified based on map data, the behavior of the forward vehicle, or data received from a roadside unit. When the target gate corresponds to a manual settlement method, the notification control unit F6 executes the eyes-on request (S302). On the other hand, when the target gate does not correspond to a manual settlement method, in other words, when the target gate is capable of executing only an automatic settlement method, the notification control unit F6 omits the eyes-on request (S303).

At gates that correspond to a manual settlement method, there is a possibility that the preceding vehicle may decelerate or stop abruptly before the gate. To address such a possibility, if the subject vehicle is scheduled to pass through a gate that corresponds to a manual settlement method, executing the eyes-on request in advance makes it easier for the driver to perform evasive maneuvers such as braking based on the behavior of the preceding vehicle.

The content of steps S302 to S303 can be replaced with steps S212 to S213. In other words, the notification control unit F6 may be configured to execute the eyes-on request in a more subtle manner if the target gate does not correspond to a manual settlement method compared to when it does correspond to a manual settlement method.

The notification control unit F6 may switch whether to execute the eyes-on request based on whether the operating mode while driving through the gate area is a hands-off capable mode. The hands-off capable mode is an operating mode in which the vehicle substantially drives automatically and the driver's hands-off is permitted. The hands-off capable mode includes the level 3 mode and the hands-off level 2 mode.

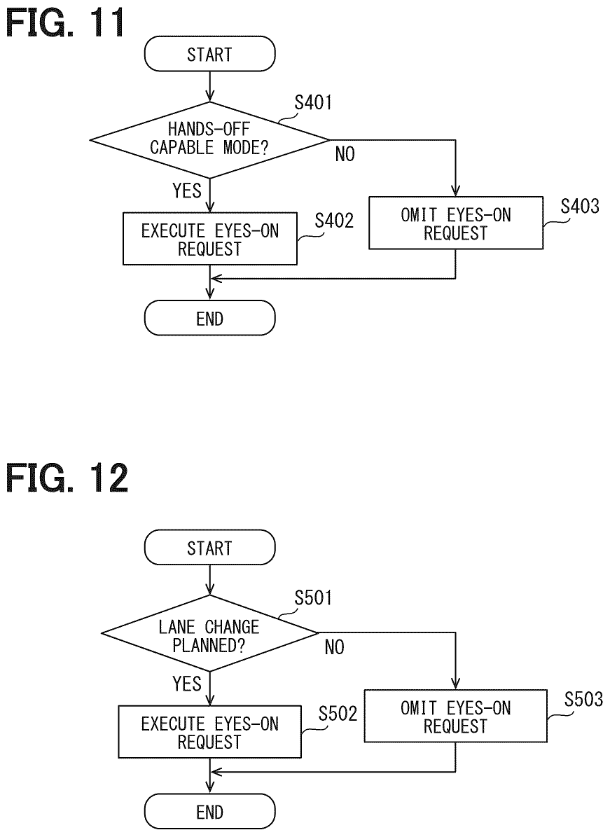

FIG. 11 illustrates an example of the operation of the notification control unit F6 based on the aforementioned technical concept. That is, as step S401, the notification control unit F6 determines whether the current operating mode (hereinafter referred to as the current mode) is the hands-off capable mode while driving through the gate area. Step S401 may be executed periodically while driving through the gate area. Step S401 may be executed only upon the occurrence of predetermined events, such as when entering the gate area, when passing through the gate, or when detecting a surrounding vehicle.

The notification control unit F6, while driving through the gate area, implements the eyes-on request (step S402) if the current mode is the hands-off capable mode (S401 YES). On the other hand, the notification control unit F6 omits the eyes-on request if the current mode is not the hands-off capable mode while driving through the gate area (S401 NO). An operation mode that is not the hands-off capable mode can be alternatively referred to as a hands-off prohibited mode or hands-on required mode. The hands-on level 2 mode corresponds to the hands-off prohibited mode.

Since the hands-off prohibited mode is originally an operation mode that presupposes the driver is eyes-on, if the current mode is the hands-off prohibited mode, an eyes-on request would correspond to an unnecessary notification for the driver. If the current mode is the hands-off prohibited mode, omitting the eyes-on request can reduce the risk of causing annoyance to the driver.

Additionally, in the hands-on level 2 mode, the driver should, in principle, also be eyes-on. However, in the hands-off level 2 mode, the driver's degree of involvement in driving operations is lower compared to the hands-on level 2 mode. Therefore, in the hands-off level 2 mode, the driver's attention is likely to be more distracted compared to the hands-on level 2 mode. In the hands-off level 2 mode, by implementing the eyes-on request again, an effect of prompting the driver's attention can be expected.

Additionally, steps S402 to S403 can be replaced with steps S212 to S213. In other words, the notification control unit F6 may be configured to implement the eyes-on request in a more subtle manner when the current mode is the hands-off prohibited mode, compared to when the current mode is the hands-off capable mode.

The notification control unit F6 may switch whether to issue an eyes-on request depending on whether a route change is scheduled after passing through the gate, as shown in FIG. 12. When a route change is scheduled after passing through the gate (S501 YES), the notification control unit F6 implements the eyes-on request (S502). On the other hand, when a plan for a route change after passing through the gate has not been created (S501 NO), the notification control unit F6 omits the eyes-on request.

Here, the route change means a lateral movement. The route change includes not only changing lanes but also driving diagonally relative to the road extension direction in a lane-free section. The lane change after passing through the gate includes changing lanes within the post-gate area.

As previously mentioned, vehicle trajectories are more likely to cross in the post-gate area compared to the pre-gate area, thereby increasing the need for surrounding monitoring. On the other hand, if a route change after passing through the gate is not planned, the need for surrounding monitoring may decrease. According to the above configuration, it is possible to enhance safety while reducing the likelihood of causing inconvenience to the driver.

Additionally, steps S502 to S503 can also be replaced with steps S212 to S213. In other words, the notification control unit F6 may be configured to implement the eyes-on request in a more subtle manner when no route change is planned after passing through the gate, compared to when a route change is planned. Additionally, the notification control unit F6 may switch the implementation of the eyes-on request depending on whether a route change in the pre-gate area is planned. Step S501 may be a step that determines whether a lane change in the pre-gate area is planned.

The notification control unit F6 may switch the implementation of the eyes-on request depending on whether there is a branch road behind the gate. The notification control unit F6 may implement the eyes-on request when there is a branch road behind the gate, while omitting the implementation of the eyes-on request when there is no branch road behind the gate. The case where there is a branch road behind the gate refers to when there is a junction within a predetermined distance behind the gate (for example, within 100 meters). When there is no branch road near the gate, the paths of the vehicles are less likely to intersect compared to when there is a branch road near the gate. According to the above configuration, unnecessary eyes-on requests can be reduced.

The notification control unit F6 may switch whether to issue the eyes-on request depending on whether the road width narrows behind the gate. The notification control unit F6 may issue the eyes-on request when the road width narrows behind the gate, while omitting the eyes-on request when the road width does not narrow behind the gate. The case where the road width narrows behind the gate corresponds to a situation where the number of lanes on the road behind the gate is fewer than the number of gates. When the number of lanes decreases after passing through the gate, merging/interruption is likely to occur, and the behavior of other vehicles may become more complex. According to the above configuration, it is possible to reduce unnecessary eyes-on requests while minimizing the risk of abnormal proximity/contact with other vehicles immediately after passing through the gate. The road structure behind the gate, such as the presence of branching roads or the reduction in road width, can be identified based on map data and the trajectory data of the forward vehicle.

### Display Control of Gate Guidance Images

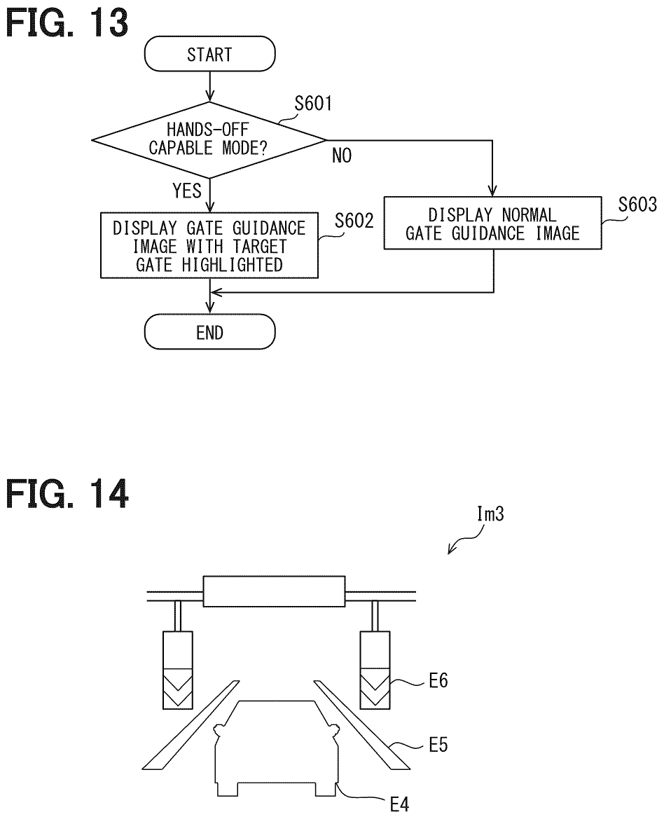

The notification control unit F6 may change the display mode of the gate guidance image Im2 depending on whether the operating mode when entering the gate area is the hands-off capable mode or not. For example, as shown in FIG. 13, if the operating mode when entering the gate area is the hands-off capable mode (S601 YES), the notification control unit F6 displays a gate guidance image Im2 with the target gate section highlighted (S602). On the other hand, if the operating mode when entering the gate area is not the hands-off capable mode (S601 NO), the notification control unit F6 displays a normal gate guidance image Im2.

The gate guidance image Im2 with the target gate section highlighted refers to an image in which the target gate section is, for example, blinking or enclosed in a frame. The normal gate guidance image Im2 is a gate guidance image Im2 without the decorations/processing applied for the hands-off capable mode.

In the hands-off capable mode, since steering is entrusted to the system, the driver may be less attentive to the gate that the subject vehicle is about to pass through compared to when a hands-on mode is applied. In the hands-off capable mode, even if the system sets a different gate as the target gate than what the driver might consider optimal, the driver is less likely to notice this. As a result, in the hands-off capable mode, there is a possibility that an override or other intervention might occur just before passing through the gate. To address such issues, according to the above configuration, the driver can more easily recognize the target gate position even in the hands-off capable mode.

The notification control unit F6 may display a gate passage icon Im3 on the display 21 instead of, or together with, the gate guidance image Im2 when the hands-off capable mode is adopted upon entering the gate area. FIG. 14 is an example of the gate passage icon Im3.

The gate passage icon Im3 includes, for example, a subject vehicle image E4, a lane line image E5, and a gate image E6. The subject vehicle image E4 is an image element representing the subject vehicle. The lane line image E5 is an image element indicating the lane lines. The gate image E6 is an image element representing the gate. The gate image E6 is an optional element and can be omitted.

The notification control unit F6 displays a gate passage icon Im3, which represents the lane line image E5 in green or white, on the display 21 when the lane lines or the edge of the gate ahead can be recognized by the camera 111 or similar device. According to this configuration, the driver can know that their subject vehicle can pass through the gate or that the system is correctly recognizing the passage position within the gate, based on the display status of the gate passage icon Im3.

On the other hand, the notification control unit F6 may display a gate passage icon Im3, which represents the lane line image E5 in gray or as a dashed line, on the display 21 when the lane lines or the edge of the gate ahead cannot be recognized by the camera 111 or similar device. The notification control unit F6 may display a gate passage icon Im3 with a question mark added near the lane line image E5 when the lane lines or the edge of the gate ahead cannot be recognized by the camera 111 or similar device. According to these configurations, the driver can know that the system has not yet recognized the passage position within the gate based on the display status of the gate passage icon Im3. Therefore, the gate passage icon Im3 is an image that indicates whether the lane lines associated with the gate are recognized or not. The gate passage icon Im3 corresponds to a passage image.

The notification control unit F6 may be configured to highlight/emphasize the lane line image E5 based on the fact that the subject vehicle is positioned in front of the target gate. The notification control unit F6 may be configured to gray out the lane line image E5 if the subject vehicle is not positioned in front of the target gate.

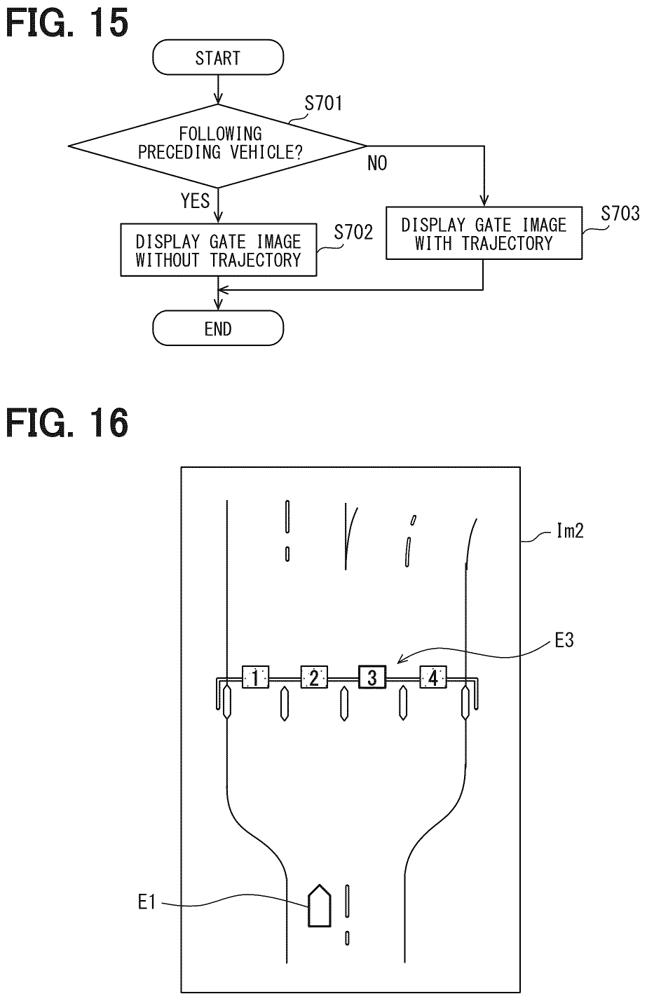

Additionally, the notification control unit F6 may change the display mode of the gate guidance image Im2 depending on whether the vehicle is following a preceding vehicle when entering the gate area. For example, as shown in FIG. 15, when the subject vehicle is following a preceding vehicle when entering the gate area (S701 YES), the notification control unit F6 displays a trajectory-free gate guidance image Im2a (S702). On the other hand, when the subject vehicle is not following a preceding vehicle when entering the gate area (S701 NO), the notification control unit F6 displays a normal gate guidance image Im2 (S703).

The trajectory-free gate guidance image Im2a is a gate guidance image that does not include the trajectory image E2, as shown in FIG. 16. The normal gate guidance image Im2 is an image that includes image elements indicating the trajectory of the subject vehicle, as illustrated in FIGS. 6 and 7. The normal gate guidance image Im2 can be referred to as a trajectory-included gate guidance image or a trajectory guidance image.

In this context, the state of the subject vehicle following a preceding vehicle refers to a situation where the function of the preceding-vehicle following control is activated and the preceding vehicle is actually being recognized. When the subject vehicle follows a preceding vehicle, the necessity to notify the driver of the subject vehicle's trajectory is smaller compared to when not following a preceding vehicle. By omitting the presentation of information that has low usefulness to the driver, the risk of causing annoyance to the driver can be reduced. Conversely, when not following a preceding vehicle, displaying the planned trajectory of the subject vehicle can provide a sense of reassurance to the driver.

The description of entering the gate area mentioned above can be understood as the timing when the remaining distance to the gate point falls below a predetermined value. Additionally, the timing after traveling a predetermined distance upon entering the gate area, or other scenarios involving traveling in the area before the gate, can be included as part of the gate area entry.

Determination of Entry into Gate Area Using a Map

The map data may include node data and link data. The node data refers to data regarding multiple feature points (nodes) on roads. For example, nodes are set at locations where roads intersect, merge, or diverge, at points where the number of lanes increases or decreases, and at gate points. The link data refers to data regarding road segments (links) that connect the nodes. The link data includes information such as a link ID that is a unique number identifying the link, a link length indicating the length of the link, a link direction, link shape information, node coordinates or node numbers of the link's start and end points, and road attributes. The node data includes information such as a node ID that is a unique number for each node, position coordinates of the nodes, the names, the types, and the link IDs of the links connected to the nodes.

Such node data may also include node map data indicating the road layout within the area related to the nodes. The node map data corresponds to partial map data within a certain range based on the nodes.

If the map data stored in the map storage unit 14 includes the node map data as described above, the processor 31 may execute various processes from step S103 onwards based on the subject vehicle entering an area indicated by the node map data associated with the gate point. In other words, the case where the subject vehicle enters the gate area also includes a case where the subject vehicle enters the area indicated by the node map data associated with the gate point. The gate area may be a range indicated by the node map data associated with the gate point. Additionally, if data indicating a range is assigned to each node, the respective ranges can correspond to the gate area.

### Control Example of Operation Mode

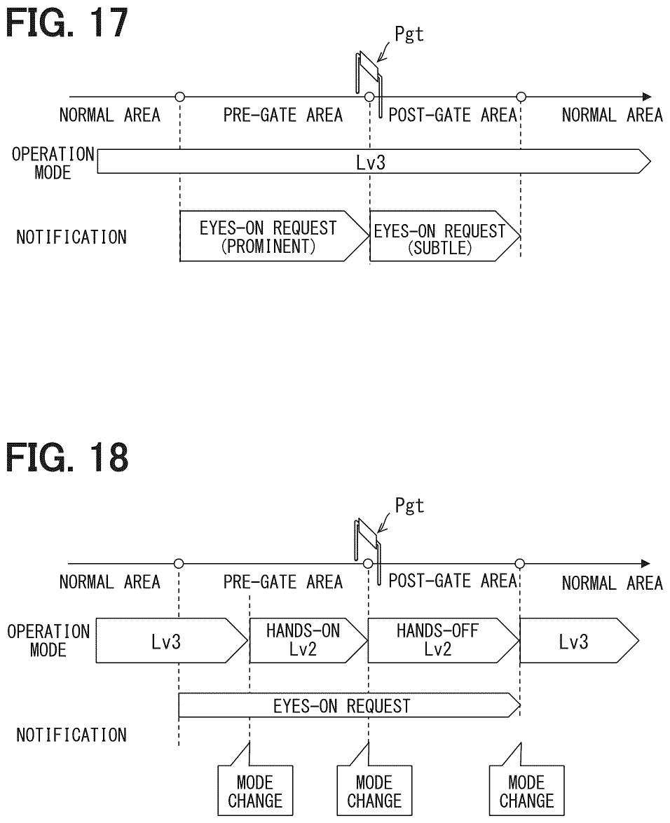

As shown in FIG. 17, the processor 31 may continue to maintain the level 3 mode even when passing through the gate. In that case, the processor 31 may request the driver to keep their eyes on the road while maintaining the level 3 mode depending on the situation. Additionally, the processor 31 may issue a TOR depending on the traffic conditions, such as the presence of a surrounding vehicle, and the complexity of the road structure. According to this configuration, the driver can act as a partner/assistant in driving operations for the system, potentially enhancing safety. Additionally, by requesting the driver to keep their eyes on the road in advance, there is the advantage that, if it becomes necessary for the driver to take over from the system, the driver can smoothly take over control of the driving operations. Furthermore, the processor 31 may transition from the level 3 mode to the hands-on level 2 mode or hands-off level 2 mode while driving through a gate area, depending on traffic conditions such as the presence of a surrounding vehicle.

Additionally, the processor 31 may be configured to temporarily transition from the level 3 mode to the level 2 mode at a predetermined timing after entering a gate area, as shown in FIG. 18. The processor 31 may automatically change the operation mode based on the position of the subject vehicle relative to the gate point. In FIG. 18, an example is illustrated where the processor 31 maintains the level 3 mode upon entering the pre-gate area, while transitioning to the hands-on level 2 mode when the remaining distance to the gate point falls below a predetermined value (for example, 100 meters). Additionally, FIG. 18 illustrates a pattern where the processor transitions to the hands-off level 2 mode at the timing of passing through the gate, and further transitions to level 3 mode at the timing of exiting the gate area. The normal area refers to a region that is neither the pre-gate area nor the post-gate area.

The timing for transitioning to the hands-on level 2 mode within the pre-gate area may be at a predetermined number of seconds (for example, 5 seconds) after the implementation of the eyes-on request. The area immediately before the gate can also become active with lateral movements (i.e., route changes) between vehicles heading towards the target gate. By transitioning to the hands-on level 2 mode in the pre-gate area, route changes towards the target gate can be carried out under the driver's responsibility. Additionally, by transitioning to the hands-on level 2 mode in the pre-gate area, it becomes easier for the driver to select any gate as the target gate.

In a case where the system is programmed to transition to the hands-on level 2 mode within the pre-gate area, it is preferable for the notification control unit F6 to implement the eyes-on request in a more pronounced manner based on the vehicle entering the gate area. According to this configuration, the driver's state can be more strongly guided to a condition suitable for the hands-on level 2 mode. Additionally, when transitioning from the level 3 mode to the hands-on level 2 mode, by requesting eyes-on before requesting hands-on rather than implementing both simultaneously, it is expected to reduce the driver's load associated with the transition of operation modes.

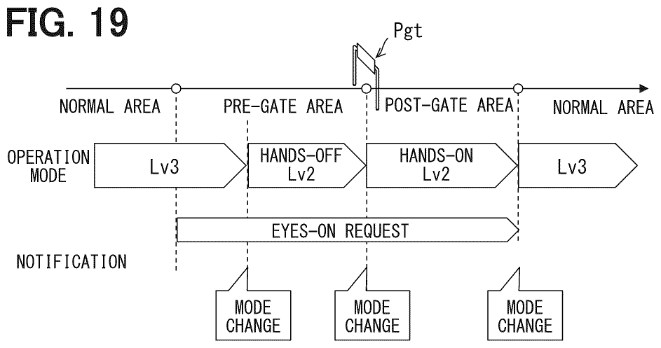

The control example for the operation mode during gate passage is not limited to this. As shown in FIG. 19, the processor 31 may transition to the hands-off level 2 mode when the remaining distance to the gate point falls below a predetermined value, and further transition to the hands-on level 2 mode at the timing of passing the gate. After passing through the gate, it is easier for the paths of vehicles to intersect due to branch roads and road width reductions. By setting the post-gate area to an operation mode that requires the driver's hands-on, it becomes possible to flexibly respond to aggressive cut-ins or abnormal proximity of other vehicles.

### Modified Example of Notification Content

The above-mentioned eyes-on request may be implemented by replacing it with a TOR (Take-Over Request) notice. In other words, the notification control unit F6 may issue a TOR notice based on the subject vehicle entering the gate area. This is because the TOR notice also effectively prompts the driver to check the surrounding situation. In other words, the TOR notice can be understood as a type of eyes-on request.

### Other Modifications

The notification control unit F6 may display a cautionary target image on the display 21 based on the vehicle entering the gate area. The cautionary target image is an image that indicates a cautionary target, which is another vehicle with a collision risk above a predetermined value. The cautionary target image may be an image indicating the direction in which the cautionary target is present. The cautionary target image may include information about the characteristics of the cautionary target, such as its color, size, or vehicle type. For example, the cautionary target image may be an overhead image depicting other vehicles around the subject vehicle, in which the cautionary target is represented in a different color from the other vehicles.

By displaying the cautionary target image, the driver can recognize the vehicle that the system is paying attention to near the gate. By implementing an eyes-on request along with the cautionary target image, it becomes possible to align the system's judgment with the driver's perception. As a result, it is expected that the driver will find it easier to trust the system. The notification control unit F6 may output a message requesting the driver to check for any other dangerous vehicles besides the cautionary target (i.e., to ensure that nothing has been overlooked).

The above technical concept involves requiring the driver to maintain eyes-on in situations where it is ordinarily unnecessary, in order to be prepared for any emergency. Such a concept can also be applied to the hands-off level 2 mode, which is one level lower in terms of automation. In situations where the hands-on operation mode is not originally required, it may be advisable to modestly request the driver to either perform hands-on or be on standby for hands-on. The notification control unit F6 may output a hands-on request based on the entry into a gate area while in the hands-off level 2 mode. The notification control unit F6, when in the hands-off level 2 mode, may replace the aforementioned eyes-on request with a hands-on request to carry out the various controls described above.

### System Configuration

The notification control unit F6 may be located outside of the automated driving ECU 30. For example, the notification control unit F6 may be provided in another computer such as an HCU (Hybrid Control Unit).

### Vehicles Applicable to the Present Disclosure

The above embodiment is applicable to a variety of vehicles that travel on roads. The present disclosure can be applied to various vehicles capable of traveling on roads, including not only four-wheeled vehicles but also two-wheeled vehicles, three-wheeled vehicles, and the like. Motorized bicycles can also be included in the two-wheeled vehicles. The subject vehicle may be an electric vehicle or an engine-powered vehicle. Electric vehicles can include not only electric cars but also plug-in hybrid vehicles, hybrid vehicles, and fuel cell vehicles. The vehicle to which the system/apparatus/method of the present disclosure is applied may be an owner car owned by an individual or a service car. The service car refers to a vehicle provided for services such as car-sharing services or vehicle rental services. The service car includes a taxi, a route bus, and a shared bus.

The notification control device mentioned above may acquire data indicating whether the vehicle is driving under autonomous control from the automated driving unit (Fn) that is configured to perform automated driving control. Additionally, the notification control device may acquire information regarding gate points, which are points where multiple gates are provided on toll roads, from the output signals of surrounding monitoring sensors, wireless signals received from external devices, or map data. The determination of whether the vehicle has entered a gate area defined based on a gate point may also be made based on the output signals of surrounding monitoring sensors, wireless signals received from external devices, or map data.

The various flowcharts presented in the present disclosure are merely examples, and the number of steps constituting the flowcharts or the execution order of the processes can be modified as appropriate. The various process flows presented in the present disclosure may be implemented in parallel with other processes, in combination with other processes, or as partial replacements for other processes. Expressions in the present disclosure referring to a remaining distance to a gate point being less than a predetermined value may be replaced with expressions indicating that the subject vehicle has entered the gate area. For example, step S102 may be a step that determines whether the subject vehicle has entered the gate area.

Additionally, the apparatus, system, and methods described in the present disclosure may be implemented by a dedicated computer comprising a processor programmed to execute one or more functions embodied in a computer program. The apparatus and methods described in the present disclosure may also be implemented using dedicated hardware logic circuits. The apparatus and methods described in the present disclosure may be implemented by one or more dedicated computers comprising a combination of a processor executing a computer program and one or more hardware logic circuits. For example, some or all of the functions provided by the processor 31 may be implemented as hardware. Implementation of a certain function as hardware includes using one or more integrated circuits (ICs). As the processor (arithmetic core), a CPU, an MPU, a GPU, a DFP (Data Flow Processor), or the like can be adopted. Some or all of the functions provided by the processor 31 may be implemented using a System-on-Chip (SoC), Integrated Circuit (IC), or Field-Programmable Gate Array (FPGA). The computer program may be stored as instructions executed by a computer on a computer-readable non-transitory tangible storage medium. As a storage medium for storing the computer program, a hard disk drive (HDD), a solid state drive (SSD), a flash memory, or the like can be adopted. A program for enabling the computer to function as the processor 31, as well as non-transitory tangible recording media such as semiconductor memory that store this program, are also within the scope of this disclosure.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A notification control device for use in a vehicle configured to execute automated driving control, the notification control device comprising a controller configured to carry out:
acquiring data indicating whether the vehicle is operating under the automated driving control;
acquiring information about a gate point which is a point where multiple gates are provided on a toll road;
determining whether the vehicle has entered a gate area defined with reference to the gate point; and
executing a notification to prompt a driver to check a surrounding traffic condition based on the vehicle entering the gate area under the automated driving control.

2. The notification control device according to claim 1, wherein the controller is further configured to carry out:
continuing the notification until the vehicle passes through a gate; and
terminating the notification based on the vehicle having passed through the gate.

3. The notification control device according to claim 1, wherein the controller is further configured to carry out continuing the notification until the vehicle exits the gate area.

4. The notification control device according to claim 1, wherein the controller is further configured to carry out:
acquiring data of another vehicle present in vicinity of the vehicle; and
terminating the notification when there is no other vehicle present in the vicinity of the vehicle.

5. The notification control device according to claim 1, wherein the controller is further configured to carry out:
acquiring data of another vehicle present in vicinity of the vehicle; and
reducing an intensity of the notification when there is no other vehicle present in the vicinity of the vehicle, compared to when another vehicle is present in the vicinity of the vehicle.

6. The notification control device according to claim 1, wherein the controller is further configured to carry out:
acquiring data indicating a settlement method of a target gate that is a gate through which the vehicle passes;
executing the notification when the target gate is a gate that allows manual settlement; and
omitting the notification when the target gate is a gate that does not allow manual settlement.

7. The notification control device according to claim 1, wherein
the vehicle is configured to selectively implement a hands-off prohibited mode, in which a driver is required to hold a steering wheel during the automated driving control, and a hands-off capable mode, in which the driver is not required to hold the steering wheel during the automated driving control, and
the controller is further configured to carry out executing different modes of the notification when traveling through the gate area, depending on whether it is in the hands-off prohibited mode or the hands-off capable mode.

8. The notification control device according to claim 7, wherein the controller is further configured to carry out increasing an intensity of the notification when traveling through the gate area in the hands-off capable mode, compared to when traveling through the gate area in the hands-off prohibited mode.

9. The notification control device according to claim 7, wherein the controller is further configured to carry out:
displaying a gate recognition status notification image indicating that lane lines associated with a gate are recognized when traveling through the gate area in the hands-off capable mode; and
preventing displaying the gate recognition status notification image when traveling through the gate area in the hands-off prohibited mode.

10. The notification control device according to claim 1, wherein the controller is further configured to carry out:
acquiring data indicating whether a route change after passing through a gate is planned;
executing the notification when the route change after passing through the gate is planned; and
omitting the notification or reducing an intensity of the notification when the route change after passing through the gate is not planned, compared to when the route change after passing through the gate is planned.

11. The notification control device according to claim 1, wherein the controller is further configured to carry out:
acquiring data indicating whether the vehicle is following a preceding vehicle; and
displaying on a display an image in which an image element indicating a trajectory of the vehicle is superimposed on an image of the gate area when the vehicle is not following a preceding vehicle in the gate area; and
displaying on the display an image of the gate area that does not include an image element indicating a trajectory of the vehicle when the vehicle is following a preceding vehicle in the gate area.

12. The notification control device according to claim 1, wherein the controller is further configured to carry out displaying on a display a trajectory image indicating a trajectory of the vehicle until the vehicle passes through a gate such that the trajectory image is interrupted at a position overlapping with the gate.

13. The notification control device according to claim 3, wherein the controller is further configured to carry out changing a mode of the notification before and after passing through the gate point.

14. A notification control method executed by a processor included in a vehicle configured to execute automated driving control, the method comprising:
acquiring data indicating whether the vehicle is operating under the automated driving control;
acquiring information about a gate point, which is a point where multiple gates are provided on a toll road;
determining whether the vehicle has entered a gate area defined with reference to the gate point; and
executing a notification to prompt a driver to check a surrounding traffic condition based on the vehicle entering the gate area under the automated driving control.

15. A non-transitory computer readable storage medium storing a notification control program comprising instructions executed by at least one processor included in a vehicle configured to execute automated driving control, the instructions configured to, when executed by the at least one processor, cause the at least one processor to carry out:
acquiring data indicating whether the vehicle is operating under the automated driving control;
acquiring information about a gate point, which is a point where multiple gates are provided on a toll road;
determining whether the vehicle has entered a gate area defined with reference to the gate point; and
executing a notification to prompt a driver to check a surrounding traffic condition based on the vehicle entering the gate area under the automated driving control.
